(19) United States
(12) Patent Application Publication
(10) Pub. No.: US 2018/0063512 A1
(43) Pub. Date: Mar. 1, 2018

(54) IMAGE STREAMING METHOD AND ELECTRONIC DEVICE FOR SUPPORTING THE SAME

(71) Applicant: Samsung Electronics Co., Ltd., Suwon-si (KR)

(72) Inventors: Seung Seok HONG, Hwaseong-si (KR); Doo Woong LEE, Seoul (KR); Gwang Woo PARK, Gwangmyeong-si (KR); Dong Woo KIM, Suwon-si (KR); Sung Jin KIM, Seoul (KR); Ho Chul SHIN, Yongin-si (KR); Sang Jun LEE, Suwon-si (KR); Seung Bum LEE, Suwon-si (KR); Dong Hyun YEOM, Bucheon-si (KR)

(21) Appl. No.: 15/694,189

(22) Filed: Sep. 1, 2017

(30) Foreign Application Priority Data
Sep. 1, 2016 (KR) 10-2016-0112872
May 12, 2017 (KR) 10-2017-0059526

(51) Int. Cl. H04N 13/02; H04N 13/04; H04N 5/232; H04N 13/00

(52) U.S. Cl. CPC H04N 13/0278; H04N 13/044; H04N 13/0048; H04N 5/23238; H04N 13/0059; H04N 13/0484

(57) ABSTRACT

An electronic device is provided. The electronic device includes a display configured to output an image, a transceiver configured to establish a plurality of channels with an external electronic device, and a processor configured to classify a virtual three dimensional (3D) projection space around the electronic device into a plurality of regions, link each of the plurality of regions with one of the plurality of channels, receive image data over the channel linked to each of the plurality of regions via the transceiver from the external electronic device, and output a streaming image on the display based on the image data.

### CROSS-REFERENCE TO RELATED APPLICATION(S)

This application claims the benefit under 35 U.S.C. §119(a) of a Korean patent application filed on Sep. 1, 2016 in the Korean Intellectual Property Office and assigned serial number 10-2016-0112872, and of a Korean patent application filed on May 12, 2017 in the Korean Intellectual Property Office and assigned serial number 10-2017-0059526, the entire disclosure of each of which is hereby incorporated by reference.

### TECHNICAL FIELD

The present disclosure relates to a method for receiving image data from an external device and streaming an image and an electronic device for supporting the same.

### BACKGROUND

With the increase of resolution of electronic devices, with the increase of calculation speed thereof, and with the enhancement of performance of graphic processing devices thereof, three-dimensional (3D) stereoscopic image data may be output through a miniaturized and lightweight virtual reality (VR) device (e.g., a smart glass, a head mount device (HMD), or the like).

For example, the HMD may play back 360-degree panorama images. The HMD may detect motion or movement of a head of a user through an acceleration sensor and may output an image of a region he or she looks at, thus providing a variety of VR images to him or her.

Image data for outputting a 3D stereoscopic image may include image data for a region the user is watching and for a peripheral region around the region. The image data may be larger in data quantity than general images.

The above information is presented as background information only to assist with an understanding of the present disclosure. No determination has been made, and no assertion is made, as to whether any of the above might be applicable as prior art with regard to the present disclosure.

### SUMMARY

A virtual reality (VR) device according to the related art may simultaneously receive image data of all regions constituting a three dimensional (3D) projection space over one channel established between the VR device and a streaming server. Further, since images for all regions on a virtual 3D projection space are the same as each other in quality irrespective of line of sight information of the user, it is difficult for the VR device according to the related art to provide high-quality 3D images in a limited wireless communication environment.

Aspects of the present disclosure are to address at least the above-mentioned problems and/or disadvantages and to provide at least the advantages described below. Accordingly, an aspect of the present disclosure is to improve wireless streaming of images to a VR device based on a field of view (FOV) of the user.

In accordance with an aspect of the present disclosure, an electronic device is provided. The electronic device includes a display configured to output an image, a transceiver configured to establish a plurality of channels with an external electronic device, and a processor configured to classify a virtual 3D projection space around the electronic device into a plurality of regions, link each of the plurality of regions with one of the plurality of channels, receive image data over each channel linked to each of the plurality of regions via the transceiver from the external electronic device, and output a streaming image on the display based on the received image data.

In accordance with another aspect of the present disclosure, a method for streaming images and an electronic device for supporting the same provide high-quality 3D images in a limited wireless communication environment using a plurality of channels linked with regions of a 3D projection space.

In accordance with another aspect of the present disclosure, a method for streaming images and an electronic device for supporting the same output 3D image data of high image quality for a region with a high interest rate of the user and may output image data of intermediate or low image quality for another region.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to various embodiments of the present disclosure;

FIG. 2 is a flowchart illustrating an image streaming method according to various embodiments of the present disclosure;

FIGS. 3A and 3B are drawings illustrating a configuration of a streaming system according to various embodiments of the present disclosure;

FIG. 4 is a flowchart illustrating real-time streaming from a camera device according to various embodiments of the present disclosure;

FIG. 5 is a drawing illustrating an example of image capture of a camera device according to various embodiments of the present disclosure;

FIG. 6 is a drawing illustrating a storage structure of a database of a server according to various embodiments of the present disclosure;

FIG. 7A is a drawing illustrating an example of an output screen of a virtual reality (VR) output device according to various embodiments of the present disclosure;

FIG. 7B is a drawing illustrating a three-dimensional (3D) projection space of a cube according to various embodiments of the present disclosure;

FIG. 7C is a drawing illustrating an example of projecting a 3D space of a cube to a spherical surface according to various embodiments of the present disclosure;

FIG. 8A is a block diagram illustrating a configuration of an electronic device according to various embodiments of the present disclosure;

FIG. 8B is a flowchart illustrating a process of outputting image data through streaming according to various embodiments of the present disclosure;

FIG. 9 is a drawing illustrating an example of a screen in which image quality difference between surfaces is reduce using a deblocking filter according to various embodiments of the present disclosure;

FIGS. 10A and 10B are drawings illustrating an example of various types of virtual 3D projection spaces according to various embodiments of the present disclosure;

FIGS. 11A and 11B are drawings illustrating an example of a data configuration of a 3D projection space of a regular polyhedron according to various embodiments of the present disclosure;

FIGS. 12A and 12B are drawings illustrating an example of configuring one sub-image by recombining one face of a 3D projection space of a regular polyhedron according to various embodiments of the present disclosure;

FIG. 12C is a drawing illustrating an example of configuring a sub-image by combining part of two faces according to various embodiments of the present disclosure;

FIGS. 13A and 13B are drawings illustrating an example of configuring one sub-image by combining two faces of a 3D projection space of a regular polyhedron according to various embodiments of the present disclosure;

FIG. 14 is a drawing illustrating an example of configuring a sub-image by combining two faces of a 3D projection space of a regular polyhedron with part of another face according to various embodiments of the present disclosure;

FIG. 15A is a drawing illustrating an example of configuring a sub-image with respect to vertices of a 3D projection space of a regular icosahedron according to various embodiments of the present disclosure;

FIG. 15B is a drawing illustrating a data configuration of a sub-image configured with respect to vertices of a 3D projection space of a regular icosahedron according to various embodiments of the present disclosure;

FIG. 16A is a drawing illustrating an example of configuring a sub-image with respect to some of vertices of a 3D projection space of a regular octahedron according to various embodiments of the present disclosure;

FIG. 16B is a drawing illustrating a data configuration of a sub-image configured with respect to vertices of a 3D projection space of a regular octahedron according to various embodiments of the present disclosure;

FIG. 17 is a block diagram illustrating a configuration of an electronic device in a network environment according to various embodiments of the present disclosure;

FIG. 18 is a block diagram illustrating an electronic device according to various embodiments of the present disclosure; and

FIG. 19 is a block diagram illustrating a program module according to various embodiments of the present disclosure.

Throughout the drawings, it should be noted that like reference numbers are used to depict the same or similar elements, features, and structures.

### DETAILED DESCRIPTION

The following description with reference to the accompanying drawings. is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions “have”, “may have”, “include” and “comprise”, or “may include” and “may comprise” used herein indicate existence of corresponding features (for example, elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (for example, a first element) is referred to as being “(operatively or communicatively) coupled with/to” or “connected to” another element (for example, a second element), it can be directly coupled with/to or connected to the other element or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used as, for example, the expression “suitable for”, “having the capacity to”, “designed to”, “adapted to”, “made to”, or “capable of”. The term “configured to (or set to)” must not mean only “specifically designed to” in hardware. Instead, the expression “a device configured to” may mean that the device is “capable of” operating together with another device or other components. A central processing unit (CPU), for example, a “processor configured to (or set to) perform A, B, and C” may mean a dedicated processor (for example, an embedded processor) for performing a corresponding operation or a generic-purpose processor (for example, a CPU or an application processor (AP)) which may perform corresponding operations by executing one or more software programs which are stored in a memory device.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, and wearable devices. According to various embodiments of the present disclosure, the wearable devices may include accessories (for example, watches, rings, bracelets, ankle bracelets, glasses, contact lenses, or head-mounted devices (HMDs)), cloth-integrated types (for example, electronic clothes), body-attached types (for example, skin pads or tattoos), or implantable types (for example, implantable circuits).

In some embodiments of the present disclosure, the electronic device may be one of home appliances. The home appliances may include, for example, at least one of a digital versatile disc (DVD) player, an audio, a refrigerator, an air conditioner, a cleaner, an oven, a microwave oven, a washing machine, an air cleaner, a set-top box, a home automation control panel, a security control panel, a television (TV) box (for example, Samsung HomeSync™, Apple TV™, or Google TV™), a game console (for example, Xbox™ or PlayStation™), an electronic dictionary, an electronic key, a camcorder, or an electronic panel.

In another embodiment of the present disclosure, the electronic device may include at least one of various medical devices (for example, various portable medical measurement devices (a blood glucose meter, a heart rate measuring device, a blood pressure measuring device, and a body temperature measuring device), a magnetic resonance angiography (MRA), a magnetic resonance imaging (MRI) device, a computed tomography (CT) device, a photographing device, and an ultrasonic device), a navigation system, a global navigation satellite system (GNSS), an event data recorder (EDR), a flight data recorder (FDR), a vehicular infotainment device, electronic devices for vessels (for example, a navigation device for vessels and a gyro compass), avionics, a security device, a vehicular head unit, an industrial or home robot, an automatic teller's machine (ATM) of a financial company, a point of sales (POS) of a store, or an internet of things (for example, a bulb, various sensors, an electricity or gas meter, a spring cooler device, a fire alarm device, a thermostat, an electric pole, a toaster, a sporting apparatus, a hot water tank, a heater, and a boiler).

According to some embodiments of the present disclosure, the electronic device may include at least one of a furniture or a part of a building/structure, an electronic board, an electronic signature receiving device, a projector, or various measurement devices (for example, a water service, electricity, gas, or electric wave measuring device). In various embodiments of the present disclosure, the electronic device may be one or a combination of the aforementioned devices. The electronic device according to some embodiments of the present disclosure may be a flexible electronic device. Further, the electronic device according to an embodiment of the present disclosure is not limited to the aforementioned devices, but may include new electronic devices produced due to the development of technologies.

Hereinafter, electronic devices according to an embodiment of the present disclosure will be described with reference to the accompanying drawings. The term “user” used herein may refer to a person who uses an electronic device or may refer to a device (for example, an artificial electronic device) that uses an electronic device.

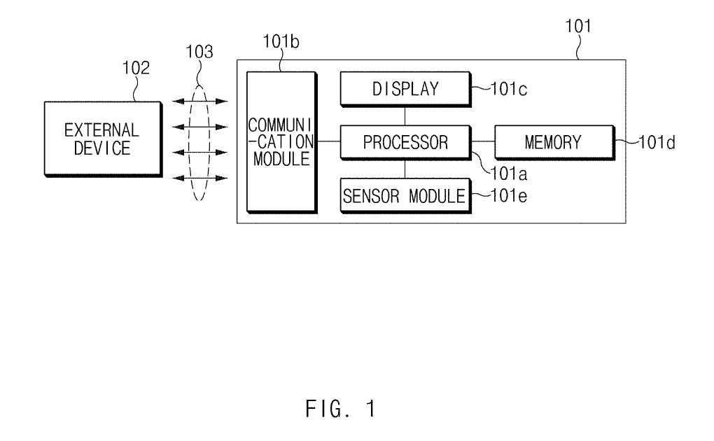

FIG. 1 is a block diagram illustrating a configuration of an electronic device according to various embodiments of the present disclosure.

Referring to FIG. 1, an electronic device 101 may be a device (e.g., a virtual reality (VR) device) for outputting a stereoscopic image (e.g., a VR image, a three-dimensional (3D) capture image, a 360-degree panorama image, or the like), a smart glass, or a head mount device (HMD). For example, the HMD may be a device (e.g., a PlayStation™ (PS) VR) including a display or a device (e.g., a gear VR) having a housing which may a smartphone. The electronic device 101 may receive a streaming image using a plurality of channels 103 from an external device 102.

In various embodiments, the electronic device 101 may include a processor 101a, a communication module 102b, a display 101c, a memory 101d, and a sensor module 101e.

The processor 101a may request the external device 102 (e.g., a streaming server) to transmit stored data via the communication module 102b and may receive image or audio data from the external device 102. The processor 101a may stream a stereoscopic image on the display 101c based on the received image or audio data.

The processor 101a may recognize a line of sight of a user (or a direction perpendicular to a surface of the display 101c) using the sensor module 101e, and may output image data corresponding to the line of sight on the display 101c or may output audio data via a speaker or an earphone. Hereinafter, an embodiment is exemplified as image data is output on a display. However, the embodiment will also be applied to if audio data is output via a speaker.

According to various embodiments, the processor 101a may classify a virtual 3D projection space into a plurality of regions and may manage image data corresponding to each of the plurality of regions to be independent of each other. For example, image data for a region currently output on the display 101c (hereinafter referred to as “output region” or “field of view (FOV)”) may vary in resolution from a peripheral region which is not output on the display 101c. The region output on the display 101c may be output based on image data of high image quality (e.g., a high frame rate or a high bit transfer rate), and the peripheral region which is not output on the display 101c may be processed at low quality (e.g., low resolution or low bit transfer rate).

For example, if the user wears the electronic device 101 on his or her head and looks at the display 101c, the processor 101a may output an image of a first region on a virtual 3D projection space on the display 101c with high image quality. If the user turns his or her head to move his or her line of sight, the electronic device 101 may also move and the processor 101a may collect sensing information via an acceleration sensor or the like included in the sensor module 101e. The processor 101a may output an image of a second region changed based on the collected information on the display 101c with high image quality.

The external device 102 may layer and manage image data for each region constituting a 3D stereoscopic space according to image quality information (e.g., a frame rate, resolution, a bit transfer rate, or the like). For example, the external device 102 may store image data for a first region as first image data of low image quality, second image data of intermediate image quality, and third image data of high image quality. The external device 102 may transmit image data of image quality corresponding to a request of the electronic device 101 over a channel linked with each region of the 3D stereoscopic space.

In various embodiments, the electronic device 101 may request the external device 102 to transmit image data of high image quality over a first channel with respect to an FOV and may request the external device 102 to transmit image data of intermediate image quality over a second channel with respect to a peripheral region around the FOV. The external device 102 may transmit the image data of the high image quality for the FOV over the first channel and may transmit the image data of the intermediate image quality for the peripheral region over the second channel.

According to various embodiments, the electronic device 101 may receive image data for a region corresponding to a line of sight of the user (or a direction perpendicular to a surface of the display 101c of the electronic device 101) with high image quality and may receive other image data with low image quality.

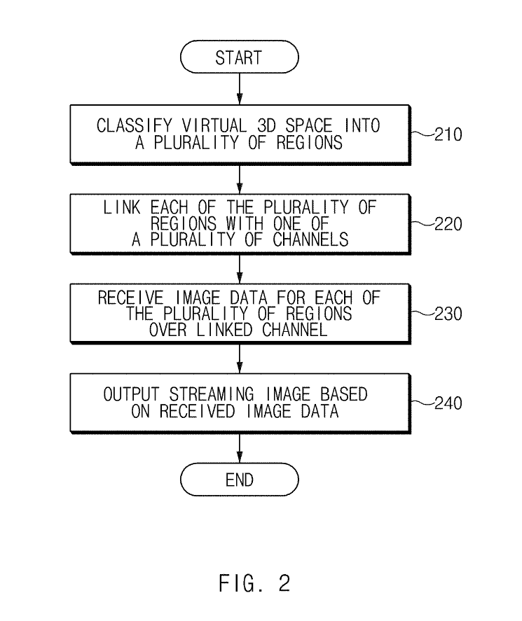

FIG. 2 is a flowchart illustrating an image streaming method according to various embodiments of the present disclosure.

Referring to FIG. 2, in operation 210, a processor 101a of FIG. 1 may classify a virtual 3D projection space around an electronic device 101 of FIG. 1 into a plurality of regions. The processor 101a may output image data for the plurality of regions in different ways. For example, the plurality of regions may be configured to have different image quality information (e.g., a frame rate, resolution, a bit transfer rate, or the like) based on image data received over different channels. The plurality of regions may output image data streamed in real time from an external device 102 of FIG. 1.

In operation 220, the processor 101a may link each of the plurality regions with one of a plurality of channels 103 of FIG. 1. For example, a first region (e.g., a front region of a user) may be linked with a first channel, and a second region (e.g., a right region of the user) may be linked with a second channel Image data received over the first channel may be output on only the first region (e.g., the front region of the user), and image data received over the second channel may be output on only the second region (e.g., the right region of the user).

In operation 230, a communication module 101b of FIG. 1 may receive image data over a channel linked to each of the plurality of regions. For example, first image data may be transmitted to the first region over the first channel, and second image data may be transmitted to the second region over the second channel.

In an embodiment, the image data for each region may have different image quality information (e.g., a frame rate, resolution, a bit transfer rate, or the like). The processor 101a may stream image data of high image quality for an FOV and may stream image data of intermediate or low image quality for the other regions.

In another embodiment, a plurality of regions constituting a virtual 3D projection space may be grouped into a plurality of groups. Image data of a region included in one group may have image quality information (e.g., a frame rate, resolution, a bit rate transfer rate, or the like) different from image data of a region include in another group.

For example, the front region of the user may be a first group, and side regions which surround the front region may be a second group. The first group may be output based on image data of relatively high resolution, and the second group may be output based on image data of relatively low resolution.

In operation 240, the processor 101a may configure the virtual 3D projection space based on each image data received over each channel. The processor 101a may synthesize respective image data. For example, the processor 101a may simultaneously output image data having the same timestamp among image data received over respective channels. The processor 101a may stream image data for a region corresponding to a line of sight of the user on a display 101c of FIG. 1.

The processor 101a may verify whether the line of sight is changed, using a sensor module (e.g., an acceleration sensor) which recognizes motion or movement of the electronic device 101. If the line of sight is changed, the processor 101a may request the external device 102 to enhance image quality for the line of sight. The external device 102 may enhance resolution of a region corresponding to the changed line of sight and may reduce resolution of a peripheral region, in response to the request of the processor 101a.

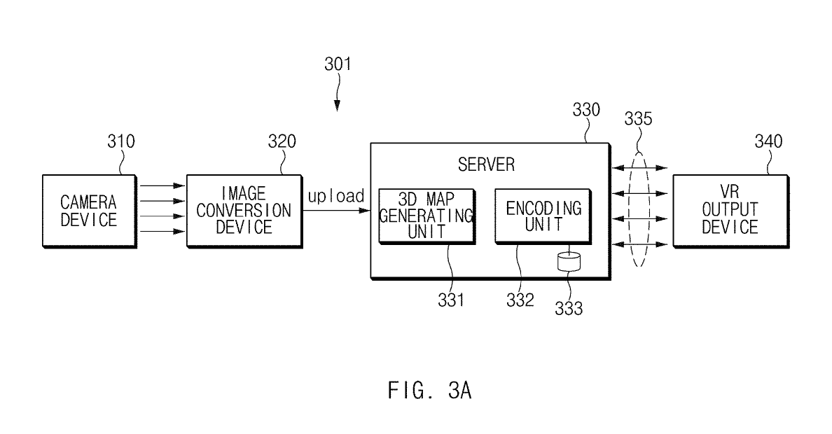

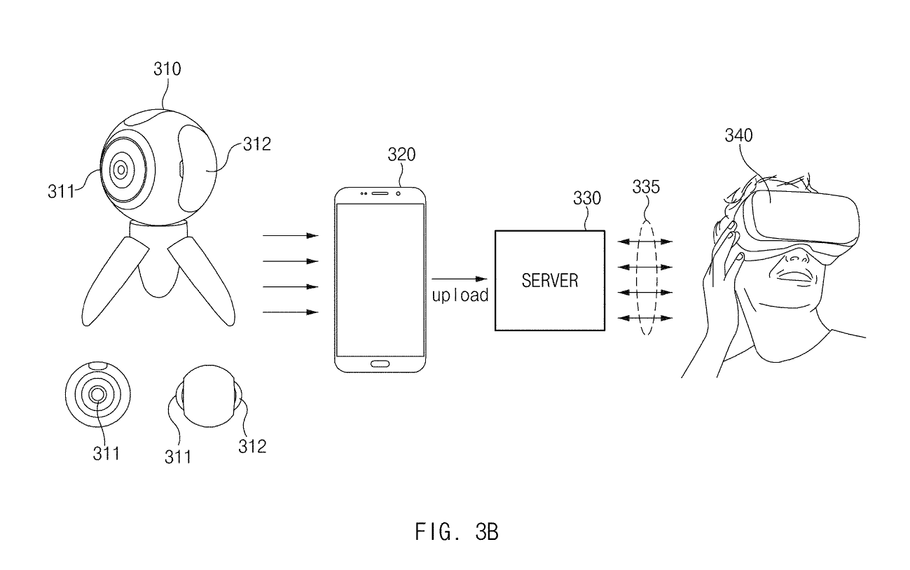

FIGS. 3A and 3B are drawings illustrating a configuration of a streaming system according to various embodiments of the present disclosure.

Referring to FIGS. 3A and 3B, a streaming system 301 may include a camera device 310, an image conversion device 320, a server 330, and the VR output device 340. The streaming system 301 may stream an image collected by the camera device 310 to the VR output device 340 in real time (or within a specified time delay range). The VR output device 340 may correspond to the electronic device 101 and the server 330 may correspond to the external device 102 in FIG. 1. The streaming system 301 may efficiently provide the user with content under a limited communication condition by relatively increasing a data amount (or an image quality) for an FOV in which a user has a high interest and relatively decreasing a data amount (or an image quality) for a region in which he or she has a low interest.

The camera device 310 may collect image data by capturing a peripheral subject. The camera device 310 may include a plurality of image sensors. For example, the camera device 310 may be a device including a first image sensor 311 located toward a first direction and a second image sensor 312 located toward a second direction opposite to the first direction.

The camera device 310 may collect image data via each of the plurality of image sensors and may process image data via a pipeline connected to each of the plurality of image sensors. The camera device 310 may store the collected image data in a buffer or memory and may sequentially transmit the stored image data to the image conversion device 320.

In various embodiments, the camera device 310 may include a short-range communication module for short-range communication such as Bluetooth (BT) or wireless-fidelity (Wi-Fi) direct. The camera device 310 may interwork with the image conversion device 320 in advance via the short-range communication module and may establish a wired or wireless communication channel Image data collected via the camera device 310 may be transmitted to the image conversion device 320 in real time over the communication channel.

According to various embodiments, the camera device 310 may collect image data having different resolution and different image quality information (e.g., a frame rate, resolution, a bit transfer rate, or the like). For example, the first image sensor 311 which captures a main subject may be configured to collect image data of high image quality. The second image sensor 312 which captures a peripheral background around the camera device 310 may be configured to collect image data of low image quality.

The image conversion device 320 may combine and transform image data collected via the plurality of image sensors of the camera device 310. For example, the image conversion device 320 may be a smartphone or a tablet personal computer (PC) linked to the camera device 310. In various embodiments, the image conversion device 320 may convert collected image data into two dimensional (2D) data or a form of being easily transmitted to the server 330.

The image conversion device 320 may perform a stitching task of stitching image data collected via the plurality of image sensors with respect to a common feature point. For example, the image conversion device 320 may combine first image data collected by the first image sensor 311 with second image data collected by the second image sensor 312 with respect to a feature point (common data) on a boundary region.

Referring to FIG. 3B, if the camera device 310 includes the first image sensor 311 and the second image sensor 312, the image conversion device 320 may remove data in an overlapped region from the first image data collected by the first image sensor 311 and the second image data collected by the second image sensor 312. The image conversion device 320 may generate one combination image by connecting a boundary between the first image data and the second image data.

The image conversion device 320 may perform conversion according to a rectangular projection based on the stitched combination image. For example, the image conversion device 320 may convert an image collected as a circle according to a shape of the camera device 310 into a quadrangular or rectangular image. In this case, an image distortion may occur in a partial region (e.g., an upper or lower end of an image).

In various embodiments, some of functions of the image conversion device 320 may be performed by another device (e.g., the camera device 310 or the server 330). For example, the conversion according to the stitching task or the rectangular projection may be performed by the server 330.

The server 330 may include a 3D map generating unit 331, an encoding unit 332, and a database 333.

The 3D map generating unit 331 may map a 2D image converted by the image conversion device 320 to a 3D space. For example, the 3D map generating unit 331 may classify a 2D image generated by the rectangular projection into a specified number of regions (e.g., 6 regions). The regions may correspond to a plurality of regions constituting a virtual 3D projection space recognized by a user, respectively, in the VR output device 340.

The 3D map generating unit 331 may generate a 3D map such that the user feels a sense of distance and a 3D effect by mapping a 2D image to each face constituting three dimensions and correcting respective pixels.

The encoding unit 332 may layer image data corresponding to one face constituting the 3D space to vary in image quality information (e.g., a frame rate, resolution, a bit transfer rate, or the like) and may store the layered image data in the database 333. For example, the encoding unit 332 may layer and code image data for a first surface into first image data of relatively high resolution, second image data of intermediate resolution, and third image data of low resolution and may divide the layered and coded image data at intervals of a constant time, thus storing the divided image data in the database 333.

In various embodiments, the encoding unit 332 may store image data by a layered coding scheme. The layered coding scheme may be a scheme of enhancing image quality of a decoding image by adding additional information of images (layer 1, layer 2, . . . ) of upper image quality to data of an image (layer 0) of the lowest image quality.

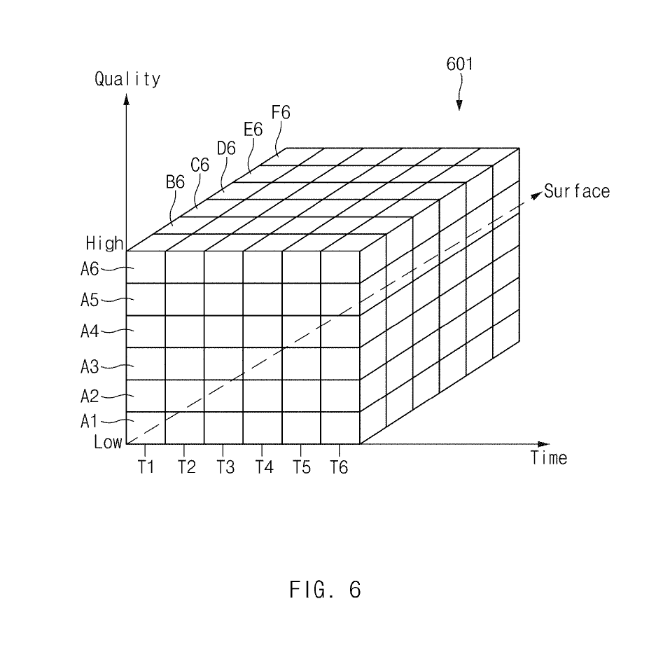

Image data corresponding to each face constituting the 3D space may be layered and stored in the database 333. Additional information about a structure of the database 333 may be provided with reference to FIG. 6.

The VR output device 340 may receive image data over a plurality of channels 335 from the server 330. The VR output device 340 may output image data forming a 3D projection space based on the received image data.

According to various embodiments, the VR output device 340 may receive and output image data of relatively high image quality with respect to an FOV the user currently looks at and may receive and output image data of intermediate or low image quality with respect to a peripheral region about the FOV.

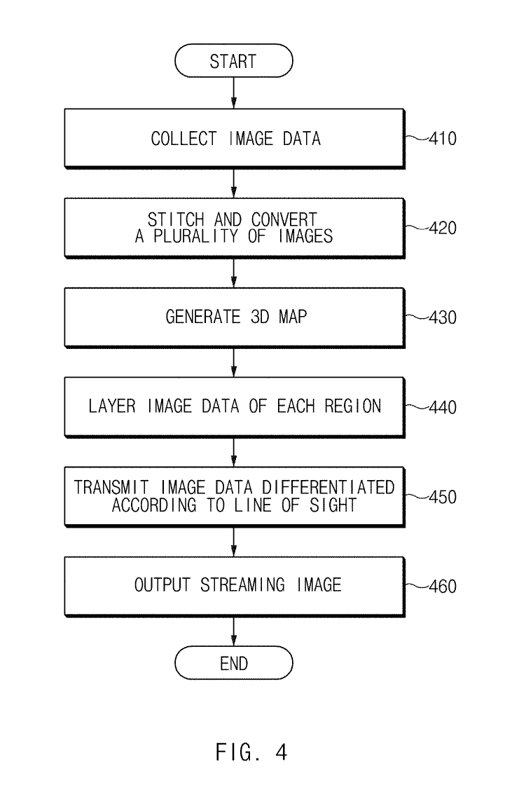

FIG. 4 is a flowchart illustrating real-time streaming from a camera device according to various embodiments of the present disclosure.

Referring to FIG. 4, in operation 410, a camera device 310 of FIG. 3A may collect image data by capturing a peripheral subject. The camera device 310 may collect a variety of image data of different locations and angles using a plurality of image sensors.

In operation 420, an image conversion device 320 of FIG. 3A may stitch the collected image data and may perform conversion according to various 2D conversion methods, for example, rectangular projection with respect to the stitched image data. The image conversion device 320 may remove common data of the collected image data to convert the collected image data into a form of easily forming a 3D map.

In operation 430, the 3D map generating unit 331 may map a 2D image converted by the image conversion device 320 to a 3D space. The 3D map generating unit 331 may map the 2D image in various forms such as a cubemap and a diamond-shaped map.

In operation 440, an encoding unit 332 of FIG. 3A may layer image data of each face (or each region) constituting a 3D map to vary in image quality information (e.g., a frame rate, resolution, a bit transfer rate, or the like). The encoding unit 332 may divide the layered image data at intervals of a constant time and may store the divided image data in the database 333. Image data having image quality information corresponding to a request of a VR output device 340 of FIG. 3A may be transmitted to the VR output device 340 over a channel.

In operation 450, the VR output device 340 may request a server 330 of FIG. 3A to transmit image data differentiated according to a line of sight of a user. The VR output device 340 may receive the image data corresponding to the request from the server 330. For example, the VR output device 340 may request the server 330 to transmit image data of relatively high image quality with respect to an FOV the user currently looks at and may receive the image data of the relatively high image quality. The VR output device 340 may request the server 330 to transmit image data of relatively intermediate or low image quality with respect to a peripheral region around the FOV and may receive the image data of the relatively intermediate or low image quality.

In operation 460, the VR output device 340 may output a streaming image based on the received image data. Each region constituting a 3D projection space may be output based on image data received over different channels. The VR output device 340 may output a high-quality image with respect to the FOV the user looks at, may output an intermediate-quality image with respect to the peripheral region, and may output a low-quality image with respect to a region which is relatively distant from the FOV.

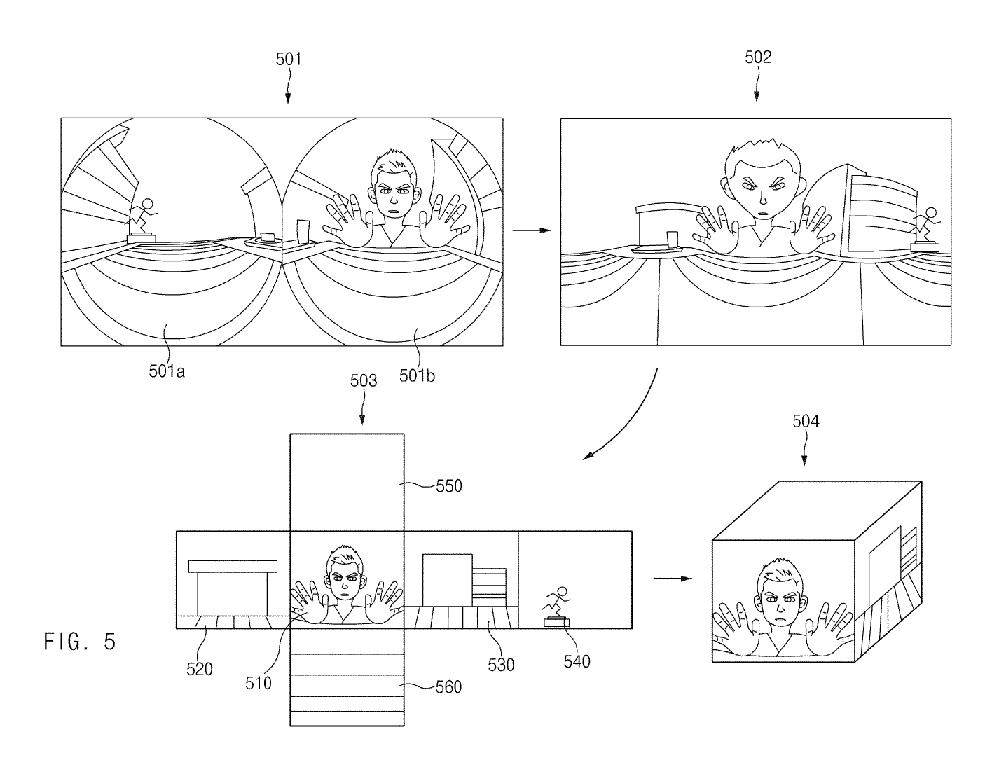

FIG. 5 is a flowchart illustrating an example of image capture of a camera device according to various embodiments of the present disclosure.

Referring to FIG. 5, a camera device 310 of FIG. 3B may include a first image sensor 311 and a second image sensor 312 of FIG. 3B. The first image sensor 311 may capture an image with an angle of view of 180 degrees or more in a first direction, and the second image sensor 312 may capture an image with an angle of view of 180 degrees or more in a second direction opposite to the first direction. Thus, the camera device 310 may obtain an image with an angle of view of 360 degrees.

The first image sensor 311 may collect first image data 501a, and the second image sensor 312 may collect second image data 501b. Each of the first image data 501a and the second image data 501b may be an image of a distorted form (e.g., a circular image) rather than a quadrangle or a rectangle according to a characteristic of a camera lens.

The camera device 310 (or an image conversion device 320 of FIG. 3B) may integrate the first image data 501a with the second image data 501b to generate an original image 501.

The image conversion device 320 may perform a stitching task for the original image 501 and may perform a conversion task according to rectangular projection to generate a 2D image 502 of a rectangular shape.

A 3D map generating unit 331 of a server 330 of FIG. 3A may generate a cubemap 503 or 504 based on the 2D image 502. In FIG. 5, an embodiment is exemplified as the cubemap 503 or 504 including six faces is formed. However, embodiments are not limited thereto.

The cubemap 503 or 504 may correspond to a virtual 3D projection space output on a VR output device 340 of FIG. 3A. Image data for first to sixth faces 510 to 560 constituting the cubemap 503 or 504 may be transmitted to the VR output device 340 over different channels.

The server 330 may layer and store image data for the first to sixth faces 510 to 560 constituting the cubemap 503 or 504 in a database 333 of FIG. 3A. For example, the server 330 may store high-quality, intermediate-quality, and low-quality images for the first to sixth faces 510 to 560.

The VR output device 340 may request the server 330 to differentiate quality of data to be played back according to a line of sight of a user. For example, the VR output device 340 may request the server 330 to transmit image data of high image quality with respect to a face including an FOV corresponding to a line of sight determined by recognition information of a sensor module (or a face, at least part of which is overlapped with the FOV) and may request the server 330 to transmit image data of intermediate or low image quality image data with respect to a peripheral region around the FOV.

The user may view a high-quality image with respect to an FOV he or she currently looks at. If the user turns his or her head to look at another region, the FOV may be changed. Although image data of intermediate image quality is streamed in a changed FOV immediately after the user turns his or her head, image data of high image quality may be streamed in the changed FOV with respect to a subsequent frame.

According to various embodiments, the VR output device 340 may request the server 330 to transmit image data based on priority information. For example, the fifth face 550 and the sixth face 560 which may be portions the user does not frequently see or which are not important may be set to be relatively low in importance. On the other hand, the first to fourth faces 510 to 540 may be set to be relatively high in importance. The VR output device 340 may continue requesting the server 330 to transmit image data of low image quality with respect to the fifth face 550 and the sixth face 560 and may continue requesting the server 330 to transmit image data of high image quality with respect to the first to fourth faces 510 to 540.

In one embodiment, the priority information may be determined in advance in a process of capturing an image at the camera device 310. For example, the camera device 310 may set importance for image data of the fifth face 550 and the sixth face 560 to a relatively low value and may record the set value in the process of capturing the image.

FIG. 6 is a drawing illustrating a storage structure of a database of a server according to various embodiments of the present disclosure.

Referring to FIG. 6, image data corresponding to each face constituting a 3D space may be layered and stored in a database 601 to be layered in the form of a cubemap. However, embodiments are not limited thereto. In a cubemap including first to sixth faces A to F, the database 601 may store image data for each face with different image quality over time (or according to each frame).

For example, image data for a first face A output at a time T1 may be stored as A1 to A6 according to image quality. For example, all of A1 to A6 may be data for the same image. A1 may be of the lowest resolution, and A6 may be of the highest resolution. In a similar manner, image data for second to sixth faces B to F may be stored as B1 to B6, C1 to C6, D1 to D6, and F1 to F6 according to its image quality, respectively.

In a VR output device 340 of FIG. 3A, if a face including an FOV is determined as the first face A, a server 330 of FIG. 3A may transmit A6 of the highest image quality among image data for the first face A to the VR output device 340 over a first channel. The server 330 may transmit B3, C3, D3, and E3 of intermediate image quality over second to fifth channels with respect to second to fifth faces B to F adjacent to the first surface A. The server 330 may transmit F1 of the lowest image quality among image data for a sixth face F of a direction opposite to the first face A to the VR output device 340 over a sixth channel.

In various embodiments, image quality of image data transmitted to the VR output device 340 may be determined according to a wireless communication environment. For example, if a wireless communication function is relatively high, the image data of the first face A may be selected as A4 to A6 and A4 to A6 may be transmitted. If the wireless communication function is relatively low, the image data of the first face A may be selected as A1 to A3 and A1 to A3 may be transmitted.

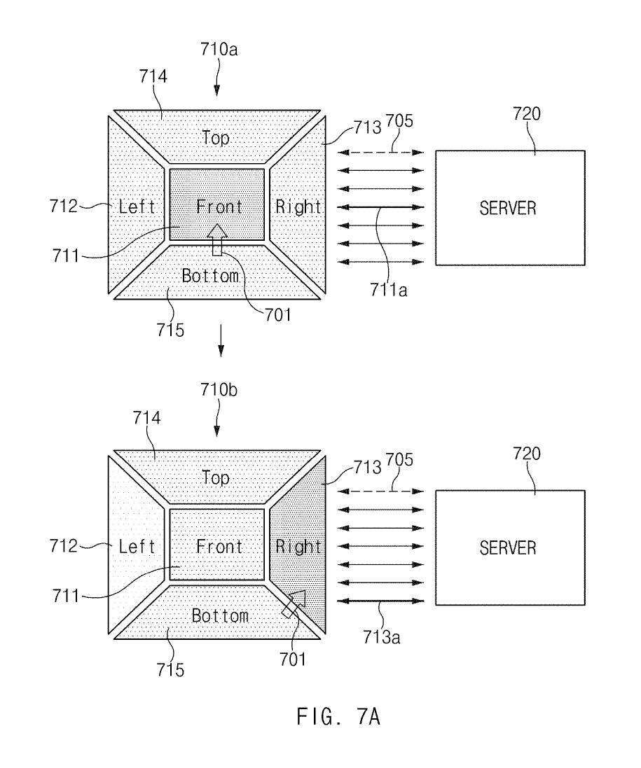

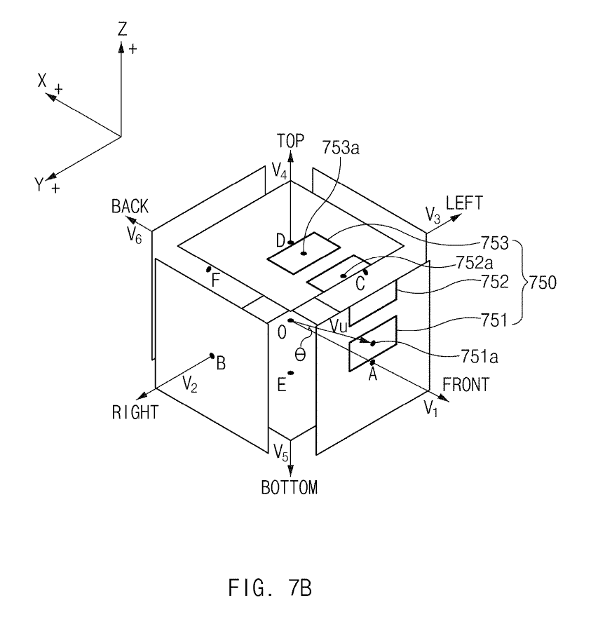

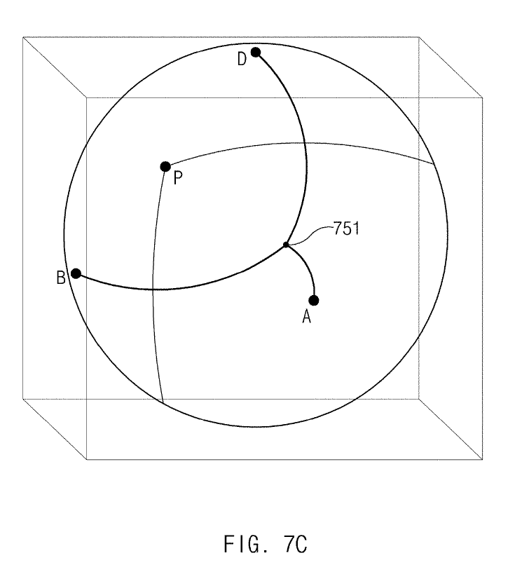

FIG. 7A is a drawing illustrating an example of an output screen of a VR output device according to various embodiments of the present disclosure.

Referring to FIG. 7A, six faces (i.e., surfaces) of a cube form may be located around a VR output device 340 of FIG. 3A. An FOV may be determined according to a line of sight 701 of a user, and image quality of each region may be varied with respect to the FOV. Different channels which may receive image data from a server 720 may be linked to each region.

In a space 710a, if the line of sight 701 of the user faces a front region 711, a face corresponding to an FOV (or a face including the FOV) may be determined as the front region 711. The VR output device 340 may request the server 720 to transmit image data of high image quality using a channel 711a corresponding to the front region 711 and may receive the image data of the high image quality. The VR output device 340 may request the server 720 to transmit image data of intermediate image quality with respect to a left region 712, a right region 713, a top region 714, or a bottom region 715 adjacent to the front region 711 and may receive the image data of the intermediate image quality. The VR output device 340 may receive image data of low image quality with respect the back region opposite to the front region 711 and may fail to receive image data with respect the back region. Alternatively, the VR output device 340 may deliberately skip a data frame and may reduce a playback frame per second (FPS), with respect to the back region in a process of requesting the server 720 to transmit data.

In a space 710b, if the line of sight 701 of the user faces the right region 713, a face corresponding to an FOV (or a face including the FOV) may be determined as the right region 713. The VR output device 340 may request the server 720 to transmit image data of high image quality using a channel 713a corresponding to the right region 713 and may receive the image data of the high image quality using the channel 713a. The VR output device 340 may request the server 720 to transmit image data of intermediate image quality with respect to the front region 711, the back region (not shown), the top region 714, or the bottom region 715 adjacent to the right region 713 and may receive the image data of the intermediate image quality. The VR output device 340 may receive image data of low image quality or may fail to receive image data, with respect to the left region 712 opposite to the right region 713 depending on a communication situation. Alternatively, the VR output device 340 may deliberately skip a data frame and may reduce a playback FPS, with respect to the left region 712 in a process of requesting the server 720 to transmit data.

According to various embodiments, a control channel 705 independent of a channel for streaming image data may be established between the VR output device 340 and the server 720. For example, the VR output device 340 may provide information about image quality to be transmitted over each streaming channel, over the control channel 705. The server 720 may determine image data to be transmitted over each streaming channel based on the information and may transmit the image data.

FIG. 7B is a drawing illustrating a 3D projection space of a cube according to various embodiments of the present disclosure.

Referring to FIG. 7B, if a 3D projection space is of a cube, a VR output device 340 of FIG. 3A may receive and play back first to sixth image data (or chunks) of the same time zone using six different channels.

According to various embodiments, the VR output device 340 may determine an output region 750 according to a line of sight of a user (e.g., a line of sight 701 of FIG. 7A). The output region 750 may be part of a 3D projection space the VR output device 340.

For example, the VR output device 340 may verify whether a line of sight is changed, using a sensor module (e.g., an acceleration sensor, a gyro sensor, or the like) which recognizes motion or movement of the VR output device 340. The VR output device 340 may determine a constant range (e.g., a rectangular range of a specified size) relative to a line of sight as an output region 750 (or an FOV).

According to various embodiments, the VR output device 340 may determine a coordinate of a central point (hereinafter referred to as “output central point”) of the output region 750. The coordinate of the output central point 751a, 752a, or 753a may be represented using a Cartesian coordinate system, a spherical coordinate system, an Euler angle, a quaternion, or the like.

According to various embodiments, the VR output device 340 may determine image quality of image data of each face based on a distance between a coordinate of the output central point 751a, 752a, or 753a and a coordinate of a central point of each face included in the 3D projection space.

For example, if a user looks at the front, the VR output device 340 may output image data included in a first output region 751. The VR output device 340 may calculate a distance between the output central point 751a and a central point A, B, C, D, E, or F of each face (hereinafter referred to as “central distance”). The VR output device 340 may request a server device to transmit image data of the front with the nearest center distance with high image quality. The VR output device 340 may request the server device to transmit image data of the back with the farthest center distance with low image quality. The VR output device 340 may request the server device to transmit image data for the other faces with intermediate image quality.

If the user moves his or her head such that a line of sight gradually moves from the front to the top, the output region 750 may sequentially be changed from the first output region 751 to a second output region 752 or a third output region 753.

If the user looks at a space between the front and the top, the VR output device 340 may output image data included in the second output region 752. The VR output device 340 may request the server device to transmit image data of the front and the top, which have the nearest central distance, with high image quality. The VR output device 340 may request the server device to transmit image data of the back and the bottom, which have the farthest central distance, with low image quality. The VR output device 340 may request the server device to transmit image data for the other faces with intermediate image quality.

If the user looks at the top, the VR output device 340 may output image data of a range included in a third output region 753. The VR output device 340 may calculate a center distance between the output central point 753a and a central point A, B, C, D, E, or F of each face. The VR output device 340 may request the server device to transmit image data of the top with the nearest center distance with high image quality. The VR output device 340 may request the server device to transmit image data of the bottom with the farthest center distance with low image quality. The VR output device 340 may request the server device to transmit image data for the other faces with intermediate image quality.

According to various embodiments, the VR output device 340 may determine a bandwidth assigned to each channel, using a vector for the central point A, B, C, D, E, or F of each face. In an embodiment, the VR output device 340 may determine the bandwidth assigned to each channel, using an angle θ between a first vector V_{U} (hereinafter referred to as “line-of-sight vector”) facing the central point 751a, 752a, or 753a of an output region (or an FOV) from a central point O of the 3D projection space and a second vector V₁, V₂, V₃, V₄, V₅, or V₆ (hereinafter referred to as “surface factor”) facing the central point A, B, C, D, E, or F of each face from the central point O.

For example, assuming that the user is located at an origin point (0, 0, 0) in a Cartesian coordinate system, the VR output device 340 may obtain a vector for a location on the 3D projection space. The VR output device 340 may obtain a vector for a central point of each face of a regular polyhedron. Assuming a cube, a vector for the central point A, B, C, D, E, or F of each face may be represented below.

Front: V₁=(x₁, y₁, z₁), Right: V₂=(x₂, y₂, z₂)

Left: V₃=(x₃, y₃, z₃), Top: V₄=(x₄, y₄, z₄)

Bottom: V₅=(x₅, y₅, z₅), Back: V₆=(x₆, y₆, Z₆)

The VR output device 340 may represent a line-of-sight vector Vu of a direction the user looks at below.

User FOV: V_{U}=(x_{U}, y_{U}, z_{U})

The VR output device 340 may obtain an angle defined by two vectors using an inner product between the line-of-sight vector V_{U} of the user and the vector for each face. As an example of the front,

$${V}_{U} \cdot {V}_{1} = \vert {V}_{U} \vert \vert {V}_{1} \vert cos {θ}_{1}$$

$${V}_{U} \cdot {V}_{1} = {x}_{u} {x}_{1} + {y}_{u} {y}_{1} + {z}_{u} {z}_{1}$$

$${θ}_{1} = {cos}^{- 1} ( \frac{{x}_{u} {x}_{1} + {y}_{u} {y}_{1} + {z}_{u} {z}_{1}}{\vert {V}_{U} \vert \vert {V}_{1} \vert} ) .$$

The VR output device 340 may obtain an angle θ₁ defined by the two vectors using the above-mentioned formulas.

The VR output device 340 may determine a priority order for each face by the percentage of an angle of the face in the sum Σᵢ₌₁⁶ θᵢ, of angles defined by all faces and the line-of-sight vector of the user and may distribute a network bandwidth according to the determined priority order. The VR output device 340 may distribute a relatively wide bandwidth to a face with a high priority order and may distribute a relatively narrow bandwidth to a face with a low priority order.

FIG. 7C is a drawing illustrating an example of projecting a 3D space of a cube to a spherical surface according to various embodiments of the present disclosure.

Referring to FIG. 7C, a VR output device 340 of FIG. 3A may project a 3D space of a cube to a spherical space in which a radius is 1.

According to various embodiments, the VR output device 340 may indicate a coordinate of a central point of each face of the cube as a Cartesian coordinate system (x, y, z).

For example, a central point D of the top may be determined as a coordinate (0, 0, 1), a central point A of the front may be determined as a coordinate (−1, 0, 0), and a central point B of the right may be determined as a coordinate (0, 1, 0). A coordinate P of a vertex adjacent to the front, the top, and the right may be determined as a coordinate

$$( \frac{- 1}{\sqrt{3}} , \frac{1}{\sqrt{3}} , \frac{1}{\sqrt{3}} ) .$$

Central points of the front, the top, and the right may be represented as a coordinate

$$( 1 , \frac{π}{2} , π )$$

on the front, a coordinate (1, 0, 0) on the top, and a coordinate

$$( 1 , \frac{π}{2} , \frac{π}{2} )$$

on the right, in a spherical coordinate system (r,θ,φ) (r≧1, 0≦θ≦π, 0≦φ≦2π).

The VR output device 340 may determine quality of image data of each face by mapping an output central point of an output region 750 of FIG. 7B, detected using a sensor module (e.g., an acceleration sensor or a gyro sensor), to a spherical coordinate and calculating a spherical distance between an output central point 751a and a central point of each face.

According to various embodiments, the VR output device 340 may determine the bandwidth assigned to each channel, using the spherical distance between a coordinate (x_{A}, y_{A}, z_{A}), (x_{B}, y_{B}, z_{B}), . . . , or (x_{F}, y_{F}, z_{F}) of the central point of each face and a coordinate (xₜ, yₜ, zₜ) of the output central point 751a.

For example, the VR output device 340 may calculate the output central point 751a of the output region as a coordinate (xₜ, yₜ, zₜ), (rₜ, θₜ, φₜ), or the like at a time t1. The VR output device 340 may calculate the spherical distance from the coordinate (xₜ, yₜ, zₜ) of the output central point 751a using the coordinate (x_{A}, y_{A}, z_{A}), (x_{B}, y_{B}, z_{B}), . . . , or (x_{F}, y_{F}, z_{F}) of the central point of each face using Equation 1 below.

$${D}_{A} = 2 r {sin}^{- 1} \frac{{d}_{A}}{2 r} , ( r = 1 ( radius ) , d = \sqrt{{( {x}_{t} - {x}_{A} )}^{2} + {( {y}_{t} - {y}_{A} )}^{2} + {( {z}_{t} - {z}_{A} )}^{2}} ) \qquad Equation 1$$

The VR output device 340 may distribute a bandwidth for each face using an available network bandwidth and the calculated spherical distance from the central point of each face using Equation 2 below.

$$Q ( {B}_{t} , {D}_{i} ) = {B}_{t} \times \frac{π - {D}_{i}}{\sum {D}_{i}} \qquad Equation 2$$

Herein, Bₜ may be a bandwidth, and Dᵢ may be a spherical distance.

According to various embodiments, the VR output device 340 may perform a bandwidth distribution process using an angle between vectors facing a central point of each face and an output central point in a spherical coordinate system, an Euler angle, a quaternion, or the like. For example, the VR output device 340 may distribute a bandwidth to be in inverse proportion to an angle defined by the output central point 751a and the central point of each face.

According to various embodiments, if a bandwidth usable by each face is determined, the VR output device 340 may apply an image quality selection method used in technology such as hypertext transfer protocol (HTTP) live streaming (HLS) or dynamic adaptive streaming over HTTP (DASH) to each face.

According to various embodiments, since there is a residual network bandwidth if a difference between a set network bandwidth and a bitrate of selected image quality occurs for a plurality of faces, the VR output device 340 may request image data of a bit rate which is higher than the set network bandwidth.

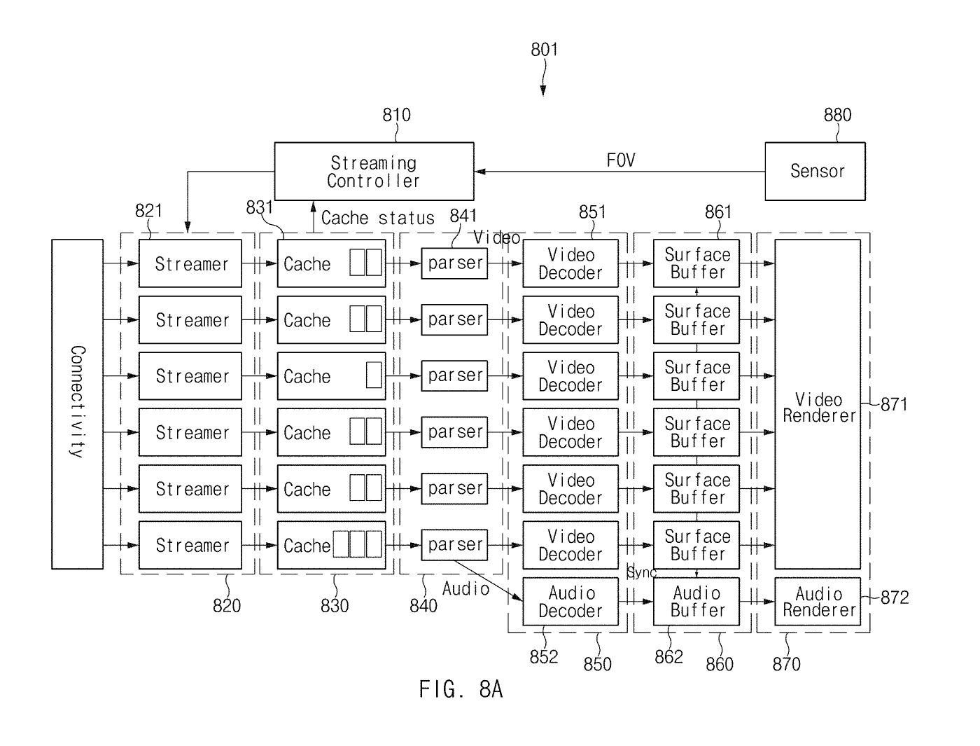

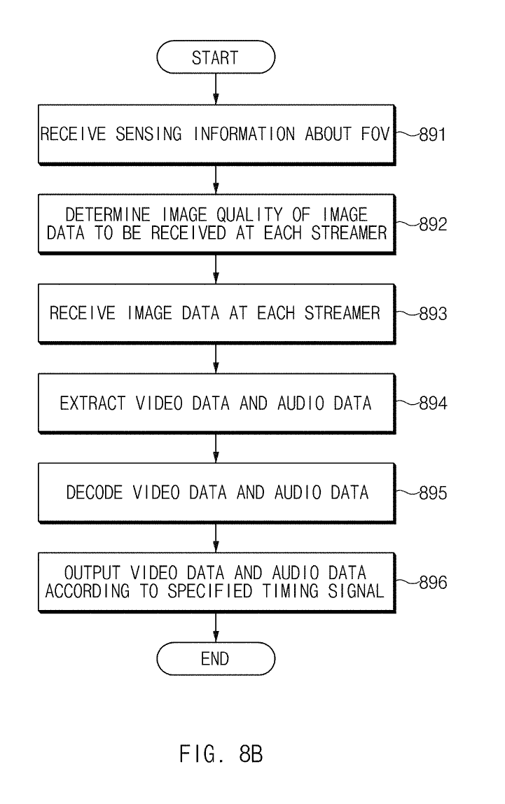

FIG. 8A is a block diagram illustrating a configuration of an electronic device according to various embodiments of the present disclosure.

Referring to FIG. 8A, an embodiment is exemplified as elements for processing and outputting video data or audio data. However, embodiments are not limited thereto. An electronic device 801 may include a streaming controller 810, a stream unit 820, a temporary storage unit 830, a parsing unit 840, a decoding unit 850, a buffer 860, an output unit 870, and a sensor unit 880.

The streaming controller 810 may control the stream unit 820 based on sensing information collected by the sensor unit 880. For example, the streaming controller 810 may verify an FOV a user currently looks at (or a face corresponding to the FOV) through the sensing information. The streaming controller 810 may determine one of streamers 821 included in the stream unit 820 corresponding to the FOV of the user and may adjust a priority order of streaming, a data rate, resolution of image data, or the like. In various embodiments, the streaming controller 810 may be a processor 101a of FIG. 1.

In various embodiments, the streaming controller 810 may receive status information of a cache memory 831 from the temporary storage unit 830. The streaming controller 810 may control the stream unit 820 based on the received status information to adjust an amount or speed of transmitted image data.

The stream unit 820 may stream image data based on control of the streaming controller 810. The stream unit 820 may include streamers corresponding to the number of regions (or surfaces) included in an output virtual 3D space. For example, in case of a 3D projection space of a cubemap as illustrated with reference to FIG. 7B, the stream unit 820 may include first to sixth streamers 821. Image data output via each of the streamers 821 may be output through a corresponding surface.

The temporary storage unit 830 may temporarily store image data transmitted via the stream unit 820. The temporary storage unit 830 may include cache memories corresponding to the number of the regions (or surfaces) included in the output virtual 3D space. For example, in case of the 3D projection space of the cubemap as illustrated with reference to FIG. 7B, the temporary storage unit 830 may include first to sixth cache memories 831. Image data temporarily stored in each of the first to sixth cache memories 831 may be output through a corresponding surface.

The parsing unit 840 may extract video data and audio data from image data stored in the temporary storage unit 830. For example, the parsing unit 840 may extract substantial image data by removing a header or the like added for communication among the image data stored in the temporary storage unit 830 and may separate video data and audio data from the extracted image data. The parsing unit 840 may include parsers 841 corresponding to the number of the regions (or surfaces) included in the output virtual 3D space.

The decoding unit 850 may decode the video data and the audio data separated by the parsing unit 840. In various embodiments, the decoding unit 850 may include video decoders 851 for decoding video data and an audio decoder 852 for decoding audio data. The decoding unit 850 may include the video decoders 851 corresponding to the number of regions (or surfaces) included in the output virtual 3D space.

The buffer 860 may store the decoded video and audio data before outputting a video or audio via the output unit 870. The buffer 860 may include video buffers (or surface buffers) 861 and an audio buffer 862. The buffer 860 may include the video buffers 861 corresponding to the number of the regions (or surfaces) included in the output virtual 3D space.

According to various embodiments, the streaming controller 810 may provide the video data and the audio data stored in the buffer 860 to the output unit 870 according to a specified timing signal. For example, the streaming controller 810 may provide video data stored in the video buffers 861 to the video output unit 871 (e.g., a display) according to a timing signal relative to the audio data stored in the audio buffer 862.

The output unit 870 may include the video output unit (or a video renderer) 871 and an audio output unit (or an audio renderer) 872. The video output unit 871 may output an image according to video data. The audio output unit 872 may output a sound according to audio data.

The sensor unit 880 may provide line-of-sight information (e.g., an FOV or a direction of view) of the user to the streaming controller 810.

According to various embodiments, the streaming controller 810 may control buffering based on an FOV. If reception of image data is delayed on a peripheral surface around a surface determined as an FOV, the streaming controller 810 may fail to perform a separate buffering operation. The streaming controller 810 may deliberately skip reception of image data which is being received to be output on the peripheral surface and may reduce playback FPS to reduce a received amount of data. The streaming controller 810 may receive image data for an interval subsequent to the skipped interval.

According to various embodiments, the streaming controller 810 may play back a different-quality image per surface according to movement of an FOV. The streaming controller 810 may quickly change image quality according to movement of an FOV using a function of swapping data stored in the buffer 860.

For example, when a face corresponding to an FOV is a front region, n^{th} video data may be being played back via the video output unit 871 and n+2^{th} video may be being received. A left, right, top, or bottom region adjacent to the front region may receive the n+2th video data of lower image quality than the front region. If the face corresponding to the FOV is changed to the left or right region, the streaming controller 810 may verify a current bitrate of a network and may doubly receive n+1^{th} or n+2^{th} video data rather than n+3^{th} image data. The streaming controller 810 may replace video data of low image quality, stored in the video buffers 861, with video data of high image quality.

In FIG. 8A, an embodiment is exemplified as the virtual 3D projection space is of the six faces (e.g., a cubemap). However, embodiments are not limited thereto. For example, the streaming controller 810 may classify a virtual 3D projection space into eight faces or ten faces and may perform rendering for each face.

According to various embodiments, the streaming controller 810 may be configured to group a plurality of surfaces and have different image quality information (e.g., a frame rate, resolution, a bit transfer rate, or the like) for each group to prevent deterioration in performance when a plurality of surfaces are generated. For example, a first streamer, a first cache memory, a first parser, a first video decoder, and a first buffer may process image data of a first group. A second streamer, a second cache memory, a second parser, a second video decoder, and a second buffer may process image data of a second group.

According to various embodiments, if using a mapping method (e.g., icosahedrons mapping) which exceeds the number of surfaces which may be processed, the streaming controller 810 may integrate video data of a plurality of polyhedron faces included in an FOV which is being viewed by a user into data of one surface and may process the integrated data. For example, in case of the icosahedrons mapping, the streaming controller 810 may process video data for 3 or 4 of faces included in a regular icosahedron.

FIG. 8B is a flowchart illustrating a process of outputting image data through streaming according to various embodiments of the present disclosure.

Referring to FIG. 8B, in operation 891, a streaming controller 810 of FIG. 8A may receive sensing information about an FOV of a user from a sensor unit 880 of FIG. 8A.

In operation 892, the streaming controller 810 may determine image quality of image data to be received at each of streamers (e.g., first to sixth streamers), based on the sensing information. The streaming controller 810 may request each of the streamers to transmit image data using a plurality of channels (or control channels) connected with an external streaming server.

In operation 893, each of the streamers 821 may receive the image data. Image quality of image data received via the streamers 821 may differ from each other. Each of the streamers 821 may store the image data in a corresponding cache memory 831 of FIG. 8A.

In operation 894, a parser 841 may extract video data and audio data from the image data stored in the cache memory 831. For example, the parser 841 may extract substantial image data by removing a header or the like added for communication among the image data stored in the cache memory 831. Further, the parser 841 may combine packets of image data in a specified order (e.g., a time order, a playback order, or the like). If video data and audio data are included in image data, the parser 841 may separate the video data and the audio data.

In operation 895, the decoding unit 850 may decode the extracted video data and audio data. For example, the video decoders 851 may decompress video data compressed according to H.264 and may convert the decompressed video data into video data which may be played back by a video output unit 871 of FIG. 8A. The audio decoder 852 may decompress audio data compressed according to advanced audio coding (AAC).

In various embodiments, the decoded video data may be stored in a video buffer 861 of FIG. 8A, and the decoded audio data may be stored in an audio buffer 862 of FIG. 8A. The buffer 860 may include the video buffers 861 by the number of faces of classifying a virtual 3D space.

In operation 896, the streaming controller 810 may output the video data or the audio data via the video output unit 871 or the audio output unit 872 according to a specified timing signal.

In an embodiment, the streaming controller 810 may simultaneously output video data having the same timestamp among data stored in each of the video buffers 861.

In another embodiment, the streaming controller 810 may output the video data on the video output unit 871 (e.g., a display) according to a timing signal relative to audio data stored in the audio buffer 862. For example, if n^{th} audio data is output on the audio output unit 872, the streaming controller 810 may transmit video data previously synchronized with the n^{th} audio data to the video output unit 871.

An image streaming method according to various embodiments may be performed in an electronic device and may include classifying a virtual 3D projection space around the electronic device into a plurality of regions, linking each of the plurality of regions with one of a plurality of channels which receive image data from an external device, receiving image data via the channel linked to each of the plurality of regions from the external device, and outputting a streaming image on a display of the electronic device based on the received image data.

According to various embodiments, the receiving of the image data may include collecting sensing information about a direction corresponding to a line of sight of a user using a sensing module of the electronic device and determining a FOV corresponding to the direction among the plurality of regions based on the sensing information. The receiving of the image data may include receiving first image data of first image quality via a first channel linked to the FOV and receiving second image data of second image quality via a second channel linked to a peripheral region adjacent to the FOV. The outputting of the streaming image may include outputting an image on the FOV based on the first image data and outputting an image on the peripheral region based on the second image.

According to various embodiments, the receiving of the image data may include receiving third image data of third image quality via a third channel linked to a separation region separated from the FOV. The outputting of the streaming image may include outputting an image on the separation region based on the third image data.

According to various embodiments, the receiving of the image data may include limiting the reception of the image data via a third channel linked to a separation region separated from the FOV.

According to various embodiments, the receiving of the image data may include determining an image quality range of the image data received via a channel linked to each of the plurality of regions, based on a wireless communication performance.

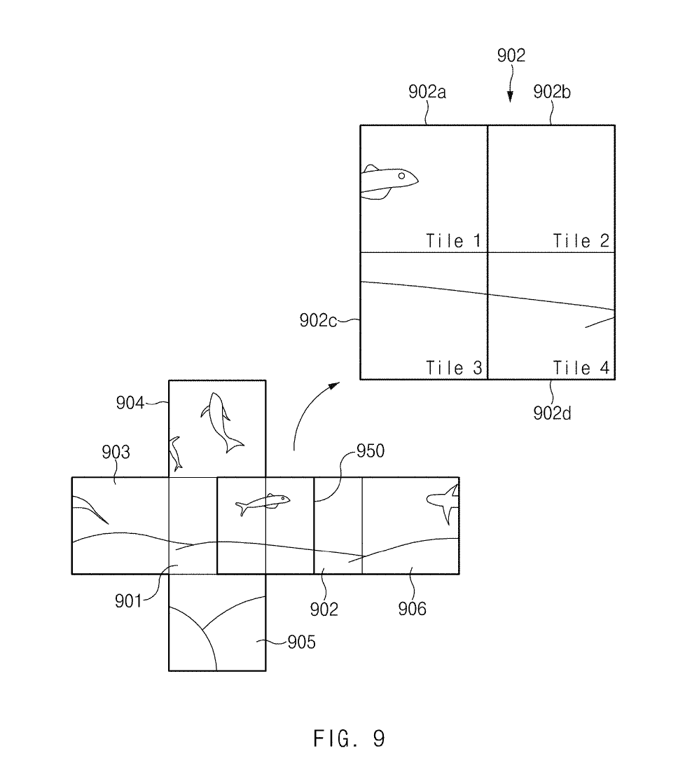

FIG. 9 is a drawing illustrating an example of a screen in which image quality difference between surfaces is reduced using a deblocking filter according to various embodiments of the present disclosure. In FIG. 9, an embodiment is exemplified as a tile scheme in high efficiency video codec (HEVC) parallelization technology is applied. However, embodiments are not limited thereto.

Referring to FIG. 9, an embodiment is exemplified as a tile scheme in high efficiency video codec (HEVC) parallelization technology is applied. However, embodiments are not limited thereto. As described above with reference to FIG. 8A, a streaming controller 810 may parallelize image data of each surface by applying the tile scheme in the HEVC parallelization technology. A virtual 3D space may include a front region 901, a right region 902, a left region 903, a top region 904, a bottom region 905, and a back region 906. The front region 901 may output image data of relatively high image quality (e.g., image quality rating 5). The right region 902, the left region 903, the top region 904, the bottom region 905, and the back region 906 may output image data of relatively low image quality (e.g., image quality rating 1).

If an FOV 950 of a user corresponds to a boundary of each face, to provide a natural screen change to him or her, the streaming controller 810 may reduce artifact of a boundary surface by applying a deblocking filter having a different coefficient value for each tile.

The streaming controller 810 may verify a surface (e.g., the front region 901 and the right region 902) to be rendered according to movement of the FOV 950 in advance. The streaming controller 810 may apply the deblocking filter to video data generated through a video decoder 851 of FIG. 8A for each block. The streaming controller 810 may effectively reduce blocking artifact by dividing the right region 902 into four tiles 902a to 902d and applying a different coefficient value to each tile.

As shown in FIG. 9, if the FOV 950 is located between the front region 901 and the right region 902, the streaming controller 810 may apply a filter coefficient with relatively high performance to the first tile 902a and the third tile 902c and may apply a filter coefficient with relatively low performance to the second tile 902b and the fourth tile 902d, on the right region 902.

In FIG. 9, an embodiment is exemplified as the FOV 950 is located on a boundary between two faces. However, embodiments are not limited thereto. For example, the FOV 950 may be located on a boundary of three faces. In this case, a filter coefficient with relatively high performance may be applied to a tile included in the FOV 950 or a tile adjacent to the FOV 950, and a filter coefficient with the lowest performance may be applied to the farthest tile from the FOV 950.

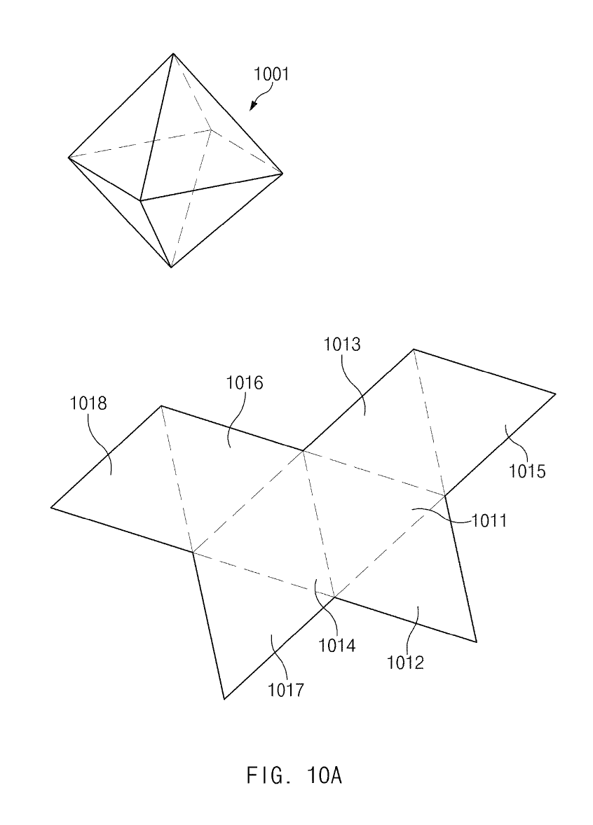

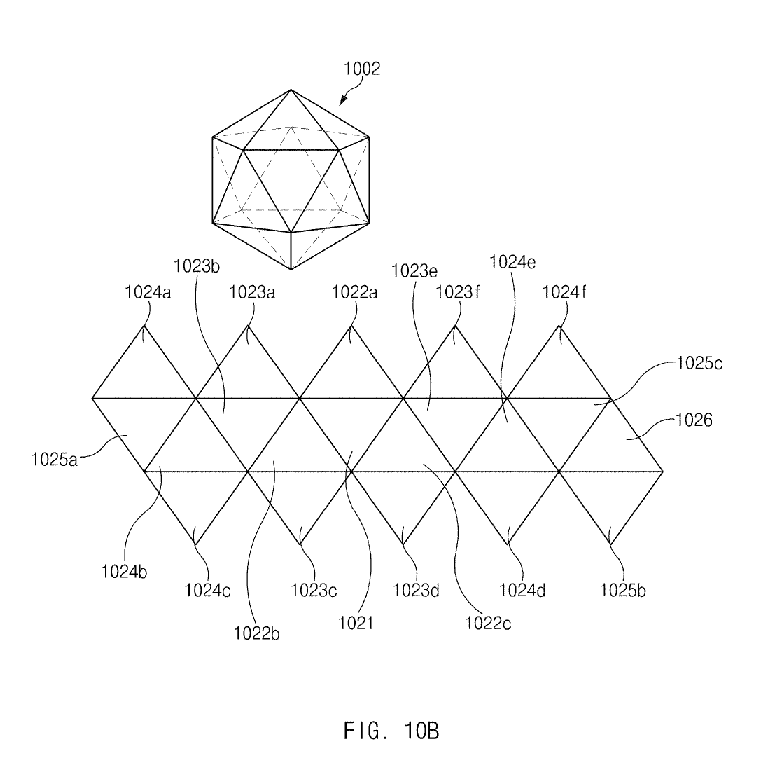

FIGS. 10A and 10B are drawings illustrating an example of various types of virtual 3D projection spaces according to various embodiments of the present disclosure.

Referring to FIG. 10A, a 3D projection space 1001 of a regular octahedron may include first to eighth faces 1011 to 1018. Each of the first to eighth faces 1011 to 1018 may be of an equilateral triangle. Image data for the first to eighth faces 1011 to 1018 may be transmitted over a plurality of streaming channels.

In various embodiments, a VR output device 340 of FIG. 3A may receive image data of a face determined as an FOV as data of relatively high image quality and may receive data of low image quality as a face is distant from the FOV. For example, if the first face 1011 is determined as the FOV, the VR output device 340 may receive image data of the highest image quality for the first face 1011 and may receive image data of the lowest image quality for the eighth face 1018 opposite to the first face 1011 (or skip the reception of the image data).

In an embodiment, the VR output device 340 may establish 8 different streaming channels with a server 330 of FIG. 3A and may receive image data for each face over each of the 8 streaming channels.

In another embodiment, the VR output device 340 may establish 4 different streaming channels with the server 330 and may receive image data for one or more faces over each of the 4 streaming channels.

For example, if the first face 1011 is determined as the FOV, the VR output device 340 may receive image data for the first face 1011 over a first streaming channel. The VR output device 340 may receive image data for the second to fourth faces 1012 to 1014 adjacent to the first face 1011 over a second streaming channel and may receive image data for the fifth to seventh faces 1015 to 1017 over a third streaming channel. The VR output device 340 may receive image data for the eighth face 1018 opposite to the first face 1011 over a fourth streaming channel. In various embodiments, the VR output device 340 may group image data received over each streaming channel and may collectively process the grouped image data.

Referring to FIG. 10B, a 3D projection space 1002 of a regular icosahedron may include first to twentieth faces 1021, 1022a to 1022c, 1023a to 1023f, 1024a to 1024f, 1025a to 1025c, and 1026. Each of the first to twentieth faces 1021, 1022a to 1022c, 1023a to 1023f, 1024a to 1024f, 1025a to 1025c, and 1026 may be of an equilateral triangle. Image data for the first to twentieth faces 1021, 1022a to 1022c, 1023a to 1023f, 1024a to 1024f, 1025a to 1025c, and 1026 may be transmitted over a plurality of streaming channels.

In various embodiments, the VR output device 340 may receive image data of a face determined as an FOV as data of relatively high image quality and may receive data of low image quality as a face is distant from the FOV. For example, if the first face 1021 is determined as the FOV, the VR output device 340 may receive image data of the highest image quality for the first face 1021 and may receive image data of the lowest image quality for the twentieth face 1026 opposite to the first face 1021 (or skip the reception of the image data).

In an embodiment, the VR output device 340 may establish 20 different streaming channels with the server 340 and may receive image data for each face over each of the 20 streaming channels.

In another embodiment, the VR output device 340 may establish 6 different streaming channels with the server 330 and may receive image data for one or more faces over each of the 6 steaming channels.

For example, if the first face 1021 is determined as the FOV, the VR output device 340 may receive image data for the first face 1021 over a first streaming channel. The VR output device 340 may receive image data for the second to fourth faces 1022a to 1022c adjacent to the first face 1011 over a second streaming channel and may receive image data for the fifth to tenth faces 1023a to 1023f over a third streaming channel. The VR output device 340 may receive image data for eleventh to 1 sixteenth faces 1024a to 1024f over a fourth streaming channel and may receive image data for the seventeenth to 10 faces 1025a to 1025c over a fifth streaming channel. The VR output device 340 may receive image data for the twentieth face 1026 opposite to the first face 1021 over a sixth streaming channel. In another embodiment, the VR output device 340 may group image data received over each streaming channel and may collectively process the grouped image data.

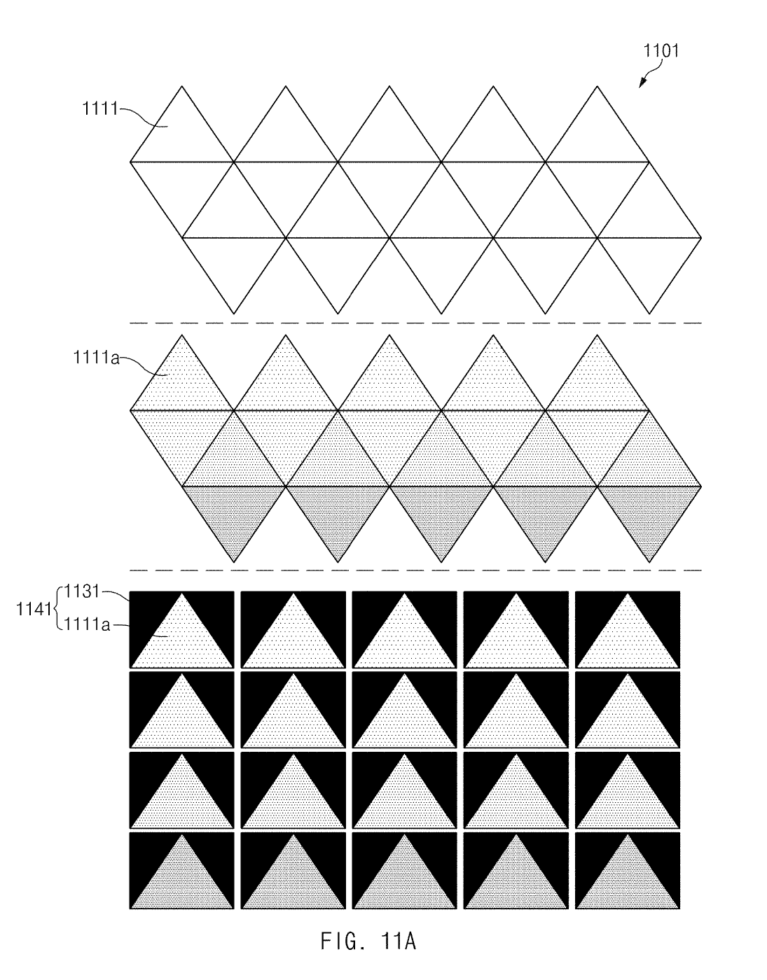

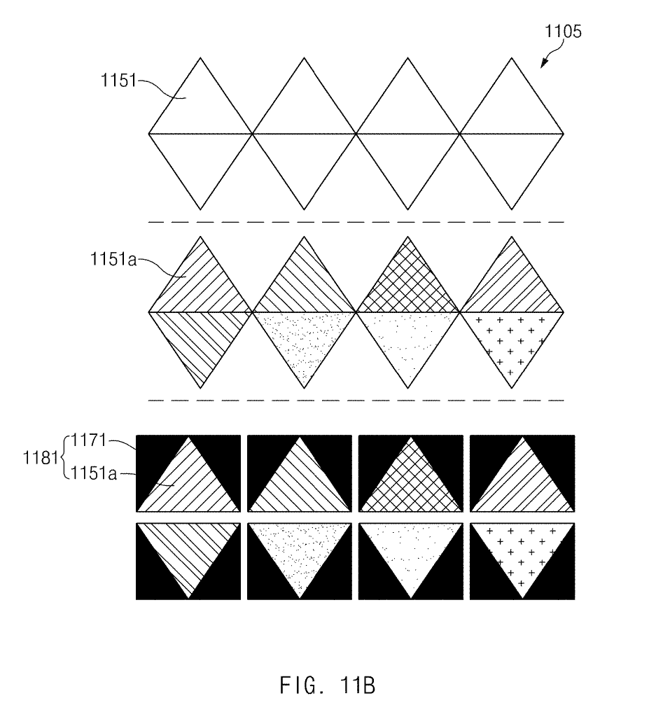

FIGS. 11A and 11B are drawings illustrating an example of a data configuration of a 3D projection space of a regular polyhedron according to various embodiments of the present disclosure.

Referring to FIGS. 11A and 11B, a server 330 of FIG. 3A may reconstitute one sub-image (or a sub-region image or an image for transmission) using image data constituting each face of a regular polyhedron. In an embodiment, the server 330 may generate one sub-image using image data for one face. Hereinafter, a description will be given of a process of generating a sub-image based on a first face 1111 or 1151, but the process may be applied to other faces.

Referring to FIG. 11A, the server 330 may generate a different sub-image corresponding to each face (or each surface) constituting a 3D projection space 1101 of a regular icosahedron.

For example, the first face 1111 of the regular icosahedron may be configured as first image data 1111a. The server 330 may change the first image data 1111a of a triangle to a first sub-image 1141 having a quadrangular frame.

According to various embodiments, the server 330 may add dummy data (e.g., black data) 1131 to the first image data 1111a to generate the first sub-image 1141 having the quadrangular frame. For example, the dummy data (e.g., the black data) 1131 may have an influence on maximum resolution which may be decoded without greatly reducing encoding efficiency.

According to various embodiments, the server 330 may layer and store the first sub-image 1141 with a plurality of image quality ratings. The server 330 may transmit the first sub-image 1141 of a variety of image quality to a VR output device 340 of FIG. 3A according to a request of the VR output device 340.

Referring to FIG. 11B, the server 330 may generate a different sub-image corresponding to each face (or each surface) constituting a 3D projection space 1105 of a regular octahedron.

For example, the first face 1151 of the regular octahedron may be configured as first image data 1151a. The server 330 may change the first image data 1151a of a triangle to a first sub-image 1181 having a quadrangular frame and may store the first sub-image 1181.

According to various embodiments, the server 330 may add dummy data (e.g., black data) 1171 to the first image data 1151a to generate the first sub-image 1181 having the quadrangular frame. For example, the dummy data (e.g., the black data) 1171 may have an influence on the maximum resolution which may be decoded without greatly reducing encoding efficiency.

According to various embodiments, the server 330 may layer and store the first sub-image 1181 with a plurality of image quality ratings. The server 330 may transmit the first sub-image 1181 of a variety of image quality to the VR output device 340 according to a request of the VR output device 340.

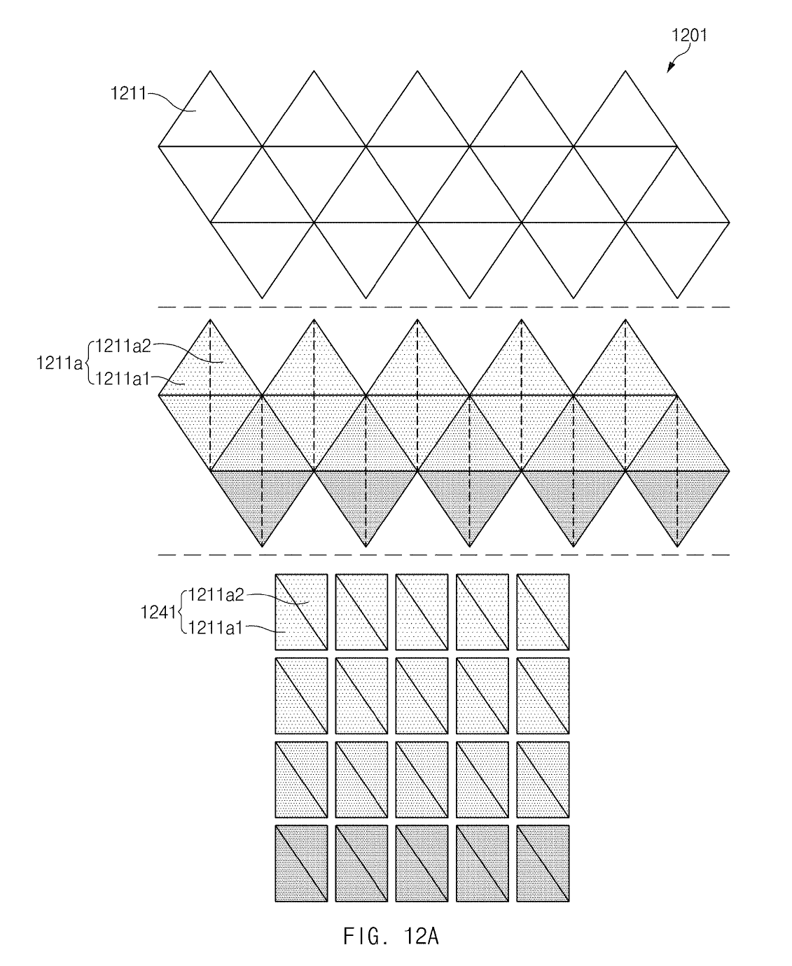

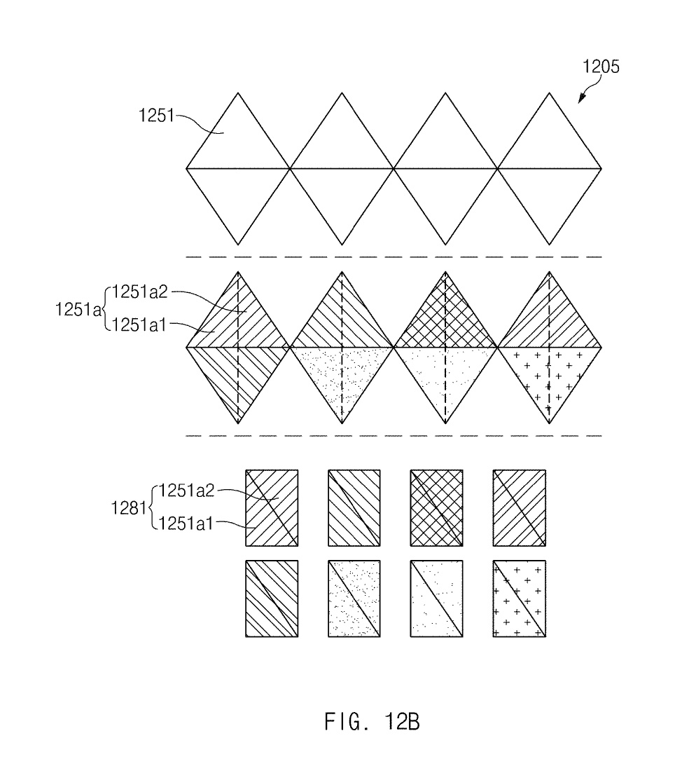

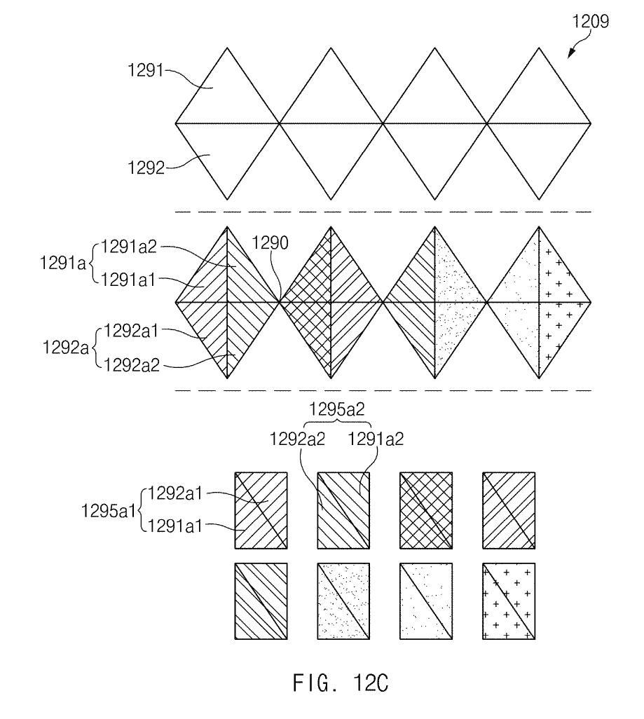

FIGS. 12A and 12B are drawings illustrating an example of configuring one sub-image by recombining one face of a 3D projection space of a regular polyhedron according to various embodiments of the present disclosure.

Referring to FIGS. 12A and 12B, a server 330 of FIG. 3A may rearrange image data constituting one face of a regular polyhedron to generate one sub-image (or a sub-region image or an image for transmission). Hereinafter, a description will be given of a process of generating a sub-image based on a first face 1211 or 1251, but the process may be applied to other faces of a regular icosahedron or a regular octahedron.

Referring to FIG. 12A, the server 330 may rearrange one face (or one surface) constituting a 3D projection space 1201 of the regular icosahedron to generate one sub-image.

For example, the first face 1211 of the regular icosahedron may be configured as first image data 1211a. The first image data 1211a may include a first division image 1211a1 and a second division image 1211a2. Each of the first division image 1211a1 and the second division image 1211a2 may be of a right-angled triangle, a hypotenuse of which is located to be toward a different direction.

A server 330 of FIG. 3A may change an arrangement form of the first division image 1211a1 and the second division image 1211a2 to generate a first sub-image 1241 having a quadrangular frame. For example, the server 330 may locate hypotenuses of the first division image 1211a1 and the second division image 1211a2 to be adjacent to each other to generate the first sub-image 1241 of a rectangle. Contrary to FIG. 11A to 11B, the server 330 may generate the first sub-image 1241 which does not include a separate dummy image. If the first sub-image 1241 does not include a separate dummy image, an influence on decoding resolution, which may occur in a frame rearrangement process, may be reduced.

According to various embodiments, the server 330 may layer and store the first sub-image 1241 with a plurality of image quality ratings. The server 330 may transmit the first sub-image 1241 of a variety of image quality to the VR output device 340 according to a request of the VR output device 340.

Referring to FIG. 12B, the server 330 may rearrange one face (or one surface) constituting a 3D projection space 1205 of the regular octahedron to generate one sub-image.

For example, the first face 1251 of the regular octahedron may be configured as first image data 1251a. The first image data 1251a may include a first division image 1251a1 and a second division image 1251a2. Each of the first division image 1251a1 and the second division image 1251a2 may be of a right-angled triangle, a hypotenuse of which is located to be toward a different direction.

The server 330 may change an arrangement form of the first division image 1251a1 and the second division image 1251a2 to generate a first sub-image 1281 having a quadrangular frame. For example, the server 330 may locate hypotenuses of the first division image 1251a1 and the second division image 1251a2 t to be adjacent to each other to generate the first sub-image 1281 of a quadrangle.

FIG. 12C is a drawing illustrating an example of configuring a sub-image by combining part of two faces according to various embodiments of the present disclosure.

Referring to FIG. 12C, a server 330 of FIG. 3A may reconfigure one sub-image (or a sub-region image or an image for transmission) using part of image data constituting two faces of a regular polyhedron. In an embodiment, the server 330 may combine part of a first face of the regular polyhedron (e.g., a regular octahedron) with part of a second face to generate a first sub-image and may combine the other part of the first face with the other part of the second face to generate a second sub-image. Hereinafter, a description will be given of a process of generating a sub-image based on a first face 1291 and a second face 1292, but the process may also be applied to other faces.

The server 330 may rearrange two faces (or two surfaces) constituting a 3D projection space 1209 of the regular octahedron to generate two sub-images.

For example, the first face 1291 of the regular octahedron may be configured as first image data 1291a. The first image data 1291a may include a first division image 1291a1 and a second division image 1291a2. Each of the first division image 1291a1 and the second division image 1291a2 may be of a right-angled triangle, a hypotenuse of which is located to be toward a different direction.

The second face 1292 of the regular octahedron may be configured as second image data 1292a. The second image data 1292a may include a third division image 1292a1 and a fourth division image 1292a2. Each of the third division image 1292a1 and the fourth division image 1292a2 may be of a right-angled triangle, a hypotenuse of which is located to be toward a different direction.

The server 330 may change an arrangement form of the first division image 1291a1 and the third division image 1292a1 to generate a first sub-image 1295a1 having a quadrangular frame. The server 330 may arrange hypotenuses of the first division image 1291a1 and the third division image 1292a1 to be adjacent to each other to generate the first sub-image 1295a1 of a quadrangle.

The server 330 may change an arrangement form of the second division image 1291a2 and the fourth division image 1292a2 to generate a second sub-image 1295a2 having a quadrangular frame. The server 330 may arrange hypotenuses of the second division image 1291a2 and the fourth division image 1292a2 to be adjacent to each other to generate the second sub-image 1295a2 of a quadrangle.

According to various embodiments, the server 330 may layer and store each of the first sub-image 1295a1 and the second sub-image 1295a2 with a plurality of image quality ratings. The server 330 may transmit the first sub-image 1295a1 or the second sub-image 1295a2 of a variety of image quality to a VR output device 340 of FIG. 3A according to a request of the VR output device 340. When compared with FIG. 12B, in the manner of FIG. 12C, the number of generated sub-images is the same as that in FIG. 12B, but the number of requested high-quality images may be reduced to from four images to two images if a user looks at a vertex 1290.

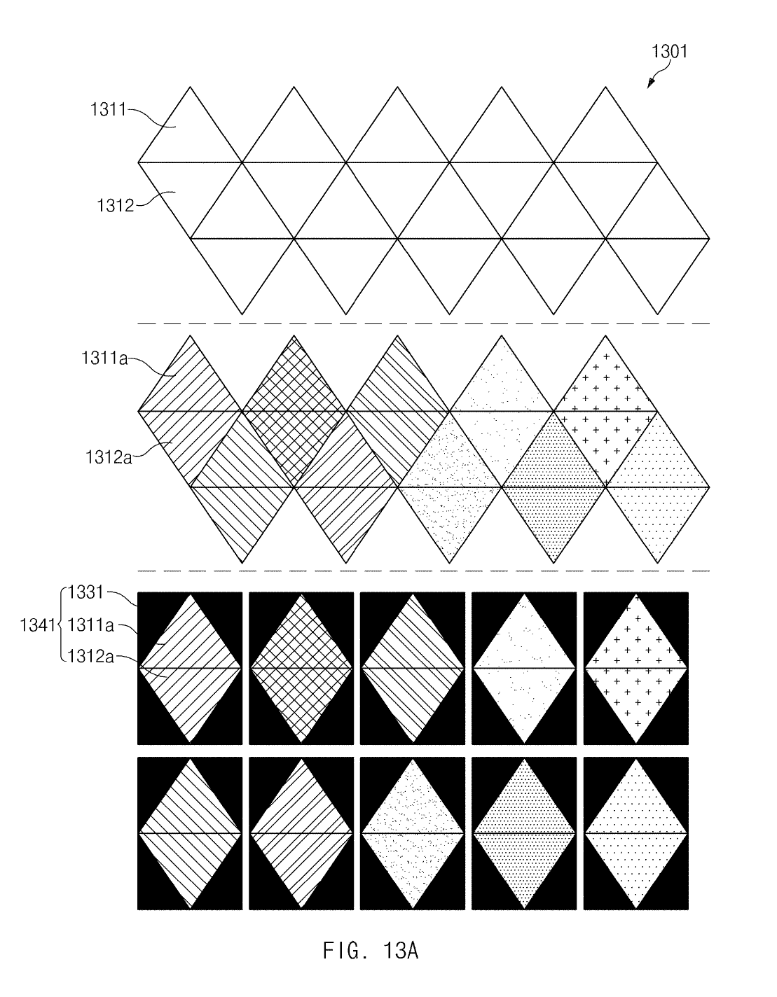

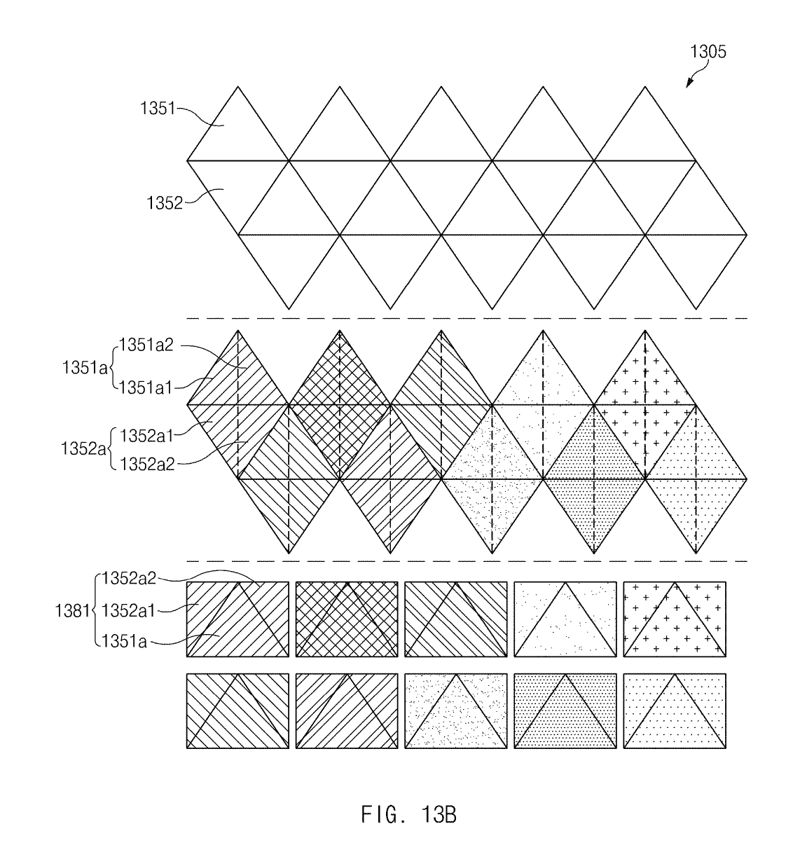

FIGS. 13A and 13B are drawings illustrating an example of configuring one sub-image by combining two faces of a 3D projection space of a regular polyhedron according to various embodiments of the present disclosure.

Referring to FIGS. 13A and 13B, if there are a number of faces constituting a regular polyhedron (e.g., a regular icosahedron), system overhead may be increased if transport channels are generated and maintained for all the faces.

A server 330 of FIG. 3A may combine image data constituting two faces of the regular polyhedron to reconfigure one sub-image (or a sub-region image or an image for transmission). Thus, the server 330 may reduce the number of transport channels and may reduce system overhead.

Hereinafter, a description will be given of a process of generating one sub-image 1341 or 1381 by combining a first face 1311 or 1351 with a second face 1312 or 1352, but the process may also be applied to other faces.

Referring to FIG. 13A, the server 330 may generate one sub-image 1341 by maintaining an arrangement form of two faces constituting a 3D projection space 1301 of the regular icosahedron and adding separate dummy data (e.g., black data).

For example, the first face 1311 of the regular icosahedron may be configured as first image data 1311a, and a second face 1312 may be configured as second image data 1312a.

The first face 1311 and the second face 1312 may be adjacent faces, and the first image data 1311a and the second image data 1312a may have a subsequent data characteristic on an adjacent face.

The server 330 may generate the first sub-image 1341 having a rectangular frame by adding separate dummy data 1331 (e.g., black data) to a periphery of the first image data 1311a and the second image data 1312a. The dummy data 1331 may be located to be adjacent to the other sides except for a side to which the first image data 1311a and the second image data 1312a are adjacent.

The server 330 may convert image data for 20 faces of the 3D projection space 1301 of the regular icosahedron into a total of 10 sub-images and may store the 10 sub-images. Thus, the number of channels for transmitting image data may be reduced, and system overhead may be reduced.

Referring to FIG. 13B, the server 330 may generate one sub-image 1381 by reconfiguring image data of two faces constituting a 3D projection space 1305 of a regular icosahedron. In this case, contrary to FIG. 13A, separate dummy data (e.g., black data) may not be added.

For example, the first face 1351 of the regular icosahedron may be configured as first image data 1351a. The first image data 1351a may include a first division image 1351a1 and a second division image 1351a2. Each of the first division image 1351a1 and the second division image 1351a2 may be of a right-angled triangle, a hypotenuse of which is located to be toward a different direction.

A second face 1352 of the regular icosahedron may be configured as second image data 1352a. The second image data 1352a may include a third division image 1352a1 and a fourth division image 1352a2. Each of the third division image 1352a1 and the fourth division image 1352a2 may be of a right-angled triangle, a hypotenuse of which is located to be toward a different direction.

The first face 1351 and the second face 1352 may be adjacent faces, and the first image data 1351a and the second image data 1352a may have a subsequent data characteristic on an adjacent face.

The server 330 may separate the second image data 1352a with an equilateral triangle from the first image data 1351a with the equilateral triangle to combine the second image data 1352a to the first image data 1351a to generate the first sub-image 1381 having a quadrangular frame. The hypotenuse of the third division data 1352a1 may be adjacent to a first side of the first image data 1351a of the equilateral triangle. The hypotenuse of the fourth division image 1352a2 may be adjacent to a second side of the first image data 1351a of the equilateral triangle.

The server 330 may convert image data for 20 faces of the 3D projection space 1305 of the regular icosahedron into a total of 10 sub-images and may store the 10 sub-images. Thus, the number of channels for transmitting image data may be reduced, and system overhead may be reduced.

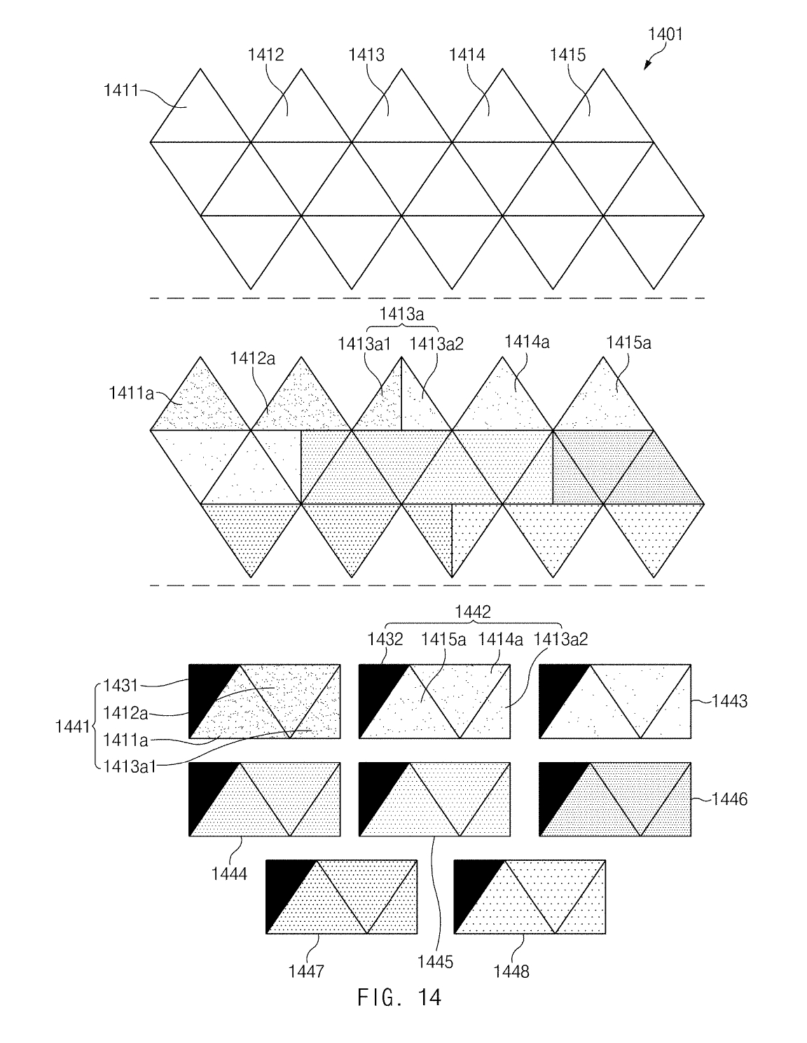

FIG. 14 is a drawing illustrating an example of configuring a sub-image by combining two faces of a 3D projection space of a regular polyhedron with part of another face according to various embodiments of the present disclosure.

Referring to FIG. 14, first and second sub-images 1441 and 1442 are generated by combining first to fifth faces 1411 to 1415 using a regular icosahedron. However, the process may also be applied other faces.

A server 330 of FIG. 3A may generate one sub-image by combining image data for two faces and part of another face constituting a 3D projection space 1401 of a regular icosahedron and adding separate dummy data (e.g., black data) to the combined image data.

For example, the first face 1411 of the regular icosahedron may be configured as first image data 1411a, and the second surface 1412 may be configured as second image data 1412a. The third face 1413 of the regular icosahedron may be configured as third image data 1413a. The third image data 1413a may be configured with first division data 1413a1 and second division data 1413a2. Each of the first division data 1413a1 and the second division data 1413a2 may be of a right-angled triangle, a hypotenuse of which is located to be toward a different direction. The fourth face 1414 of the regular icosahedron may be configured as fourth image data 1414a, and the fifth face 1415 may be configured as fifth image data 1415a.

The first to third faces 1411 to 1413 may be adjacent faces, and the first to third image data 1411a to 1413a may have a subsequent data characteristic on the adjacent face.

A server 330 of FIG. 3A may generate the first sub-image 1441 by combining the first image data 1411a, the second image data 1412a, the first division data 1413a1 of the third image data 1413a, and dummy data 1431 (e.g., black data). The server 330 may maintain an arrangement form of the first image data 1411a and the second image data 1412a, which is an equilateral triangle. The server 330 may locate the first division data 1413a1 of the third image data 1413a to be adjacent to the second image data 1412a. The server 330 may locate the dummy data 1431 (e.g., the black data) to be adjacent to the first image data 1411a. The first sub-image 1441 may have a rectangular frame.

In a similar manner, the third to fifth faces 1413 to 1415 may be adjacent faces, and the third to fifth image data 1413a to 1415a may have a subsequent data characteristic on the adjacent face.

The server 330 may generate the a second sub-image 1442 by combining the fourth image data 1414a, the fifth image data 1415a, the second division data 1413a2 of the third image data 1413a, and dummy data 1432 (e.g., black data).

The server 330 may maintain an arrangement form of the fourth image data 1414a and the fifth image data 1415a, which is an equilateral triangle. The server 330 may locate the second division data 1413a2 of the third image data 1413a to be adjacent to the fourth image data 1414a. The server 330 may locate the dummy data 1432 (e.g., the black data) to be adjacent to the fifth image data 1415a. The second sub-image 1442 may have a rectangular frame.

The process may also be applied to other faces. The server 330 may convert image data for all of the 3D projection space 1401 of the rectangular frame into a total of 8 sub-images 1441 to 1448 and may store the 8 sub-images 1441 to 1448. Thus, the number of channels for transmitting image data may be reduced, and system overhead may be reduced.

According to various embodiments, the server 330 may layer and store each of the first to eighth sub-images 1441 to 1448 with a plurality of image quality ratings. The server 330 may transmit the first to eighth sub-images 1441 to 1448 of a variety of image quality to a VR output device 340 of FIG. 3A according to a request of the VR output device 340. When compared with FIG. 11A or 12A, in the manner of FIG. 14, the total number of transport channels may be reduced from 20 to 8. If a user looks at the top of the 3D projection space 1401, the server 330 may transmit the first sub-image 1441 and the second sub-image 1442 with high image quality and may transmit the other sub-images with intermediate or low image quality.

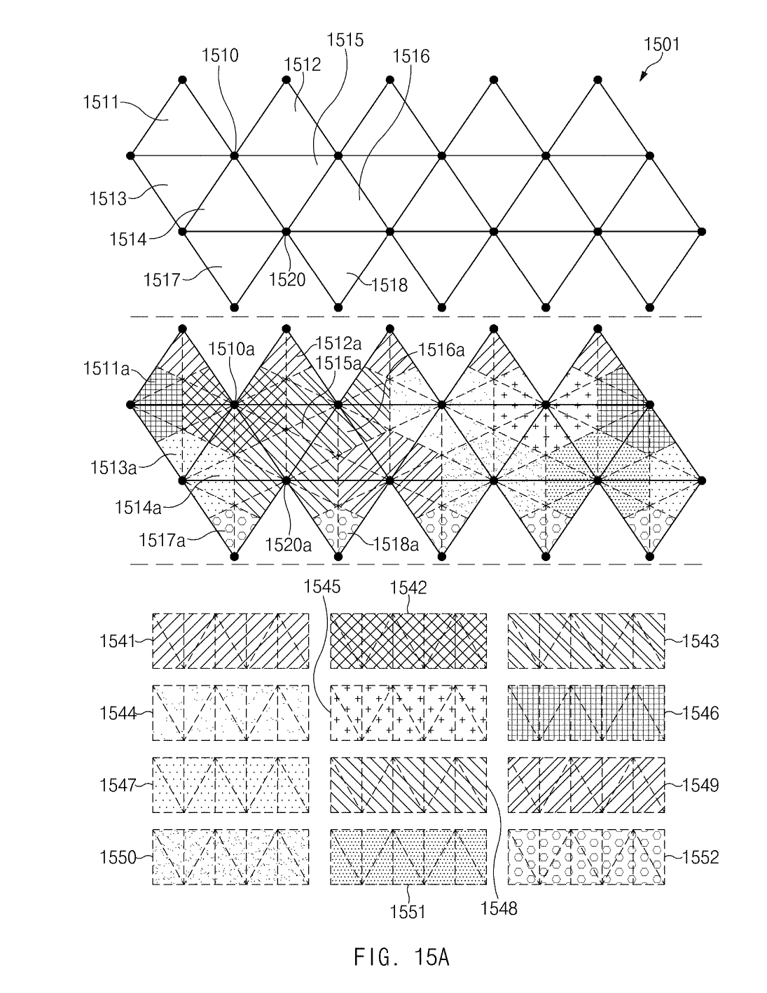

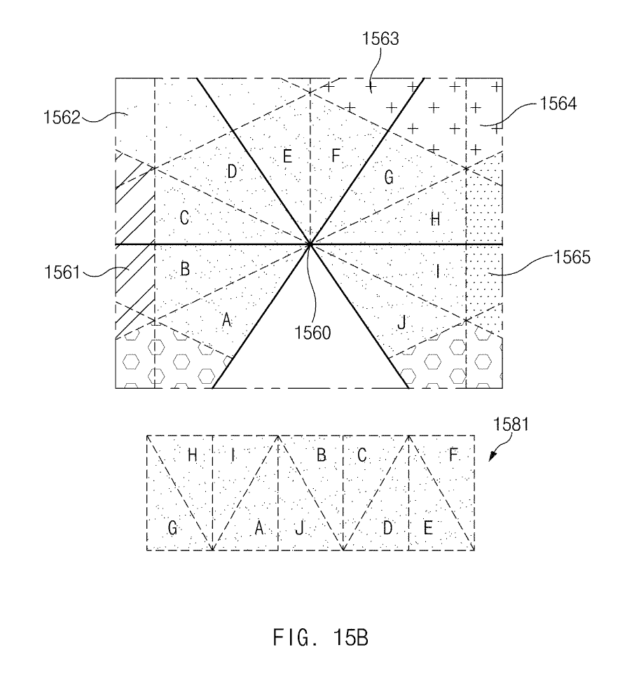

FIG. 15A is a drawing illustrating an example of configuring a sub-image with respect to vertices of a 3D projection space of a regular icosahedron according to various embodiments of the present disclosure.

Referring to FIG. 15A, a 3D projection space of a regular polyhedron using a regular icosahedron may include a vertex on which three or more faces border. A server 330 of FIG. 3A may generate one sub-image by recombining image data of faces located around one vertex of the regular polyhedron.

A sub-image is generated with respect to a first vertex 1510 and a second vertex 1520 on a 3D projection space 1501 of the regular polyhedron. However, the process may also be applied to other vertices and other faces.

The regular polyhedron may include a vertex on a point where five faces border. For example, the first vertex 1510 may be formed on a point where all of first to fifth faces 1511 to 1515 border. The second vertex 1520 may be formed on a point where all of fourth to eighth faces 1514 to 1518 border.

The server 330 may generate sub-image 1542 by combining part of each of first image data 1511a to fifth image data 1515a. The server 330 may combine some data of a region adjacent to vertex data 1510a in each image data. The generated sub-image 1542 may have a rectangular frame.

The server 330 may generate sub-image 1548 by combining part of each of fourth to eighth image data 1514a to 1518a. The server 330 may combine some data of a region adjacent to vertex data 1520a in each image data. The generated sub-image 1548 may have a rectangular frame. Additional information about a configuration of a sub-image may be provided with reference to FIG. 15B.

The server 330 may generate first to twelve sub-images 1541 to 1552 using image data for 20 faces of the 3D projection space 1501 of the regular icosahedron. Thus, the number of channels for transmitting image data may be reduced, and system overhead may be reduced.

FIG. 15B is a drawing illustrating a data configuration of a sub-image configured with respect to vertices of a 3D projection space of a regular icosahedron according to various embodiments of the present disclosure.

Referring to FIG. 15B, vertex data 1560 of a regular icosahedron may be formed on a point where all of first to fifth image data 1561 to 1565 corresponding to a first face to a fifth face border.

A server 330 of FIG. 3A may generate sub-image 1581 by combining part of each of the first to fifth image data 1561 to 1565.

For example, the server 330 may generate the sub-image 1581 by recombining first division image data A and second division image data B of the first image data 1561, third division image data C and fourth division image data D of the second image data 1562, fifth division image data E and sixth division image data F of the third image data 1563, seventh division image data G and eighth division image data H of the fourth image data 1564, and ninth division image data I and tenth division image data J of the fifth image data 1565. Each of the first to tenth division image data A to J may be of a right-angled triangle.

According to various embodiments, if respective division image data are located to be adjacent on a 3D projection space, the server 330 may locate adjacent division image data to be adjacent to each other on the sub-image 1581. The server 330 may enhance encoding efficiency by stitching regions, each of which includes consecutive images. For example, although region A and region J belong to image data of different faces, since they have consecutive images to a mutually stitched face on the regular icosahedron, region A and region J may be combined to be adjacent in the form of one equilateral triangle on the sub-image 1581.

The combination form of the sub-image 1581 in FIG. 15B is, but is not limited to, an example. The form where the first to tenth division image data A to J may be changed in various ways.

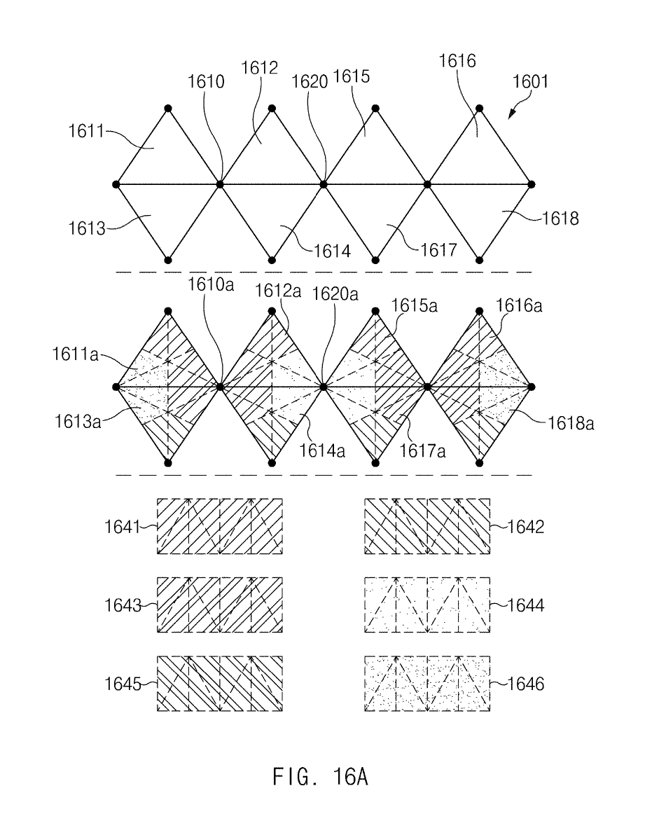

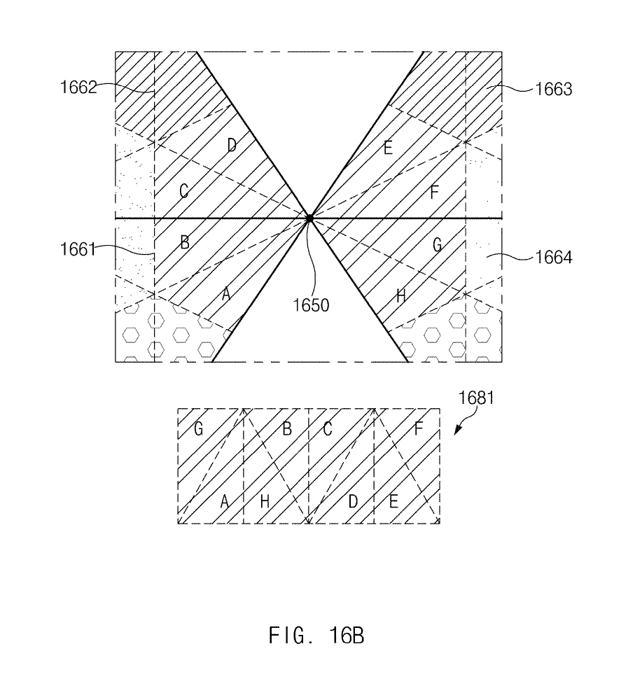

FIG. 16A is a drawing illustrating an example of configuring a sub-image with respect to some of vertices of a 3D projection space of a regular octahedron according to various embodiments of the present disclosure.

Referring to FIG. 16A, a 3D projection space of a regular polyhedron may include a vertex on which three or more faces border. A server 330 of FIG. 3A may generate one sub-image by recombining image data of faces located around one vertex of the regular octahedron.

Hereinafter, a description will be given of a process of generating each sub-image with respect to a first vertex 1610 and a second vertex 1620 on a 3D projection space 1601 of the regular polyhedron. However, the process may also be applied to other vertices and other faces.

The regular octahedron may include a vertex on a point where four faces border. For example, the first vertex 1610 may be formed on a point where all of first to fourth faces 1611 to 1614 border. The second vertex 1620 may be formed on a point where all of third to sixth faces 1613 to 1616 border.

The first to sixth face 1611 to 1616 of the regular octahedron may be configured as first to sixth image data 1611a to 1616a, respectively.

The server 330 may generate sub-image 1642 by combining part of each of first to four image data 1611a to 1614a. The server 330 may combine some data of a region adjacent to vertex data 1610a in each image data. The generated sub-image 1642 may have a rectangular frame.

The server 330 may generate one sub-image 1643 by combining part of each of the third to sixth image data 1613a to 1616a. The server 330 may combine some data of a region adjacent to vertex data 1620a in each image data. The generated sub-image 1643 may have a rectangular frame. Additional information about a configuration of a sub-image may be provided with reference to FIG. 16B.

In a similar manner, the server 330 may generate first to sixth sub-images 1641 to 1646 using image data for 8 faces of the 3D projection space 1601 of the regular octahedron. Thus, the number of channels for transmitting image data may be reduced, and system overhead may be reduced.

FIG. 16B is a drawing illustrating a data configuration of a sub-image configured with respect to vertices of a 3D projection space of a regular octahedron according to various embodiments of the present disclosure.

Referring to FIG. 16B, vertex data 1650 of a regular octahedron may be formed on a point where all of first to fourth image data 1661 to 1664 corresponding to first to four faces border.

A server 330 of FIG. 3A may generate sub-image 1681 by combining part of each of the first to fourth image data 1661 to 1664.

For example, the server 330 may generate the sub-image 1681 by recombining first division image data A and second division image data B of the first image data 1661, third division image data C and fourth division image data D of the second image data 1602, fifth division image data E and sixth division image data F of the third image data 1603, and seventh division image data G and eighth division image data H of the fourth image data 1604. Each of the first to eighth division image data A to G may be of a right-angled triangle.

According to various embodiments, if respective division image data are located to be adjacent to each other on a 3D projection space, the server 330 may locate adjacent division image data to be adjacent to each other on the sub-image 1681. The server 330 may enhance encoding efficiency by stitching regions, each of which includes consecutive images. For example, although region A and region H belong to image data of different faces, since they have consecutive images to a mutually stitched face on the regular octahedron, region A and region H may be combined to be adjacent in the form of one equilateral triangle on the sub-image 1681.

The combination form of the sub-image 1681 in FIG. 16B is, but is not limited to, an example. The form where the first to tenth division image data A to H may be changed in various ways.

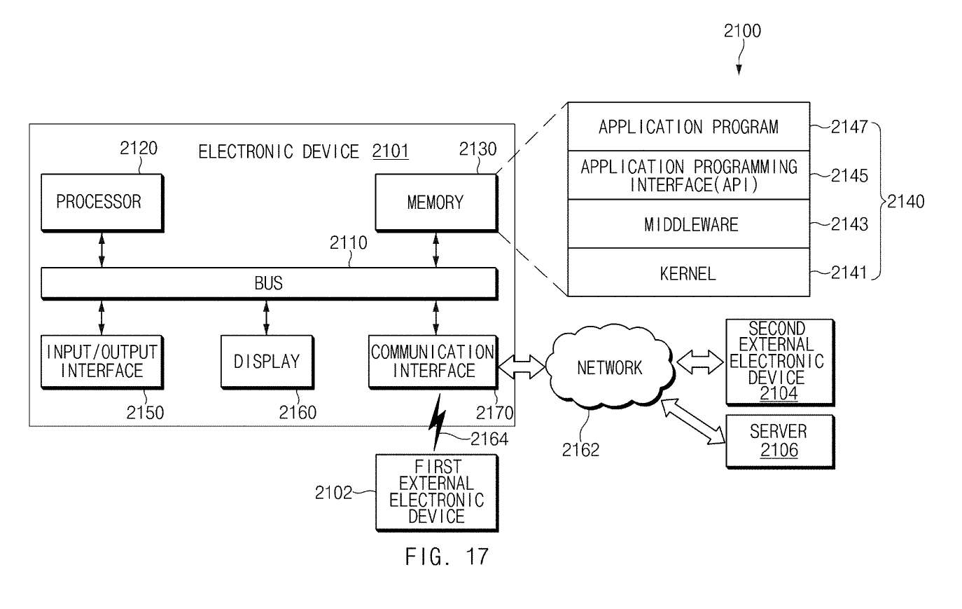

FIG. 17 is a block diagram illustrating a configuration of an electronic device in a network environment according to an embodiment of the present disclosure.

Referring to FIG. 17, an electronic device 2101 in a network environment 2100 according to various embodiments of the present disclosure will be described with reference to FIG. 17. The electronic device 2101 may include a bus 2110, a processor 2120, a memory 2130, an input/output interface 2150, a display 2160, and a communication interface 2170. In various embodiments of the present disclosure, at least one of the foregoing elements may be omitted or another element may be added to the electronic device 2101.

The bus 2110 may include a circuit for connecting the above-mentioned elements 2110 to 2170 to each other and transferring communications (e.g., control messages and/or data) among the above-mentioned elements.

The processor 2120 may include at least one of a CPU, an AP, or a communication processor (CP). The processor 2120 may perform data processing or an operation related to communication and/or control of at least one of the other elements of the electronic device 2101.

The memory 2130 may include a volatile memory and/or a nonvolatile memory. The memory 2130 may store instructions or data related to at least one of the other elements of the electronic device 2101. According to an embodiment of the present disclosure, the memory 2130 may store software and/or a program 2140. The program 2140 may include, for example, a kernel 2141, a middleware 2143, an application programming interface (API) 2145, and/or an application program (or an application) 2147. At least a portion of the kernel 2141, the middleware 2143, or the API 2145 may be referred to as an operating system (OS).

The kernel 2141 may control or manage system resources (e.g., the bus 2110, the processor 2120, the memory 2130, or the like) used to perform operations or functions of other programs (e.g., the middleware 2143, the API 2145, or the application program 2147). Furthermore, the kernel 2141 may provide an interface for allowing the middleware 2143, the API 2145, or the application program 2147 to access individual elements of the electronic device 2101 in order to control or manage the system resources.

The middleware 2143 may serve as an intermediary so that the API 2145 or the application program 2147 communicates and exchanges data with the kernel 2141.

Furthermore, the middleware 2143 may handle one or more task requests received from the application program 2147 according to a priority order. For example, the middleware 2143 may assign at least one application program 2147 a priority for using the system resources (e.g., the bus 2110, the processor 2120, the memory 2130, or the like) of the electronic device 2101. For example, the middleware 2143 may handle the one or more task requests according to the priority assigned to the at least one application, thereby performing scheduling or load balancing with respect to the one or more task requests.

The API 2145, which is an interface for allowing the application program 2147 to control a function provided by the kernel 2141 or the middleware 2143, may include, for example, at least one interface or function (e.g., instructions) for file control, window control, image processing, character control, or the like.

The input/output interface 2150 may serve to transfer an instruction or data input from a user or another external device to (an)other element(s) of the electronic device 2101. Furthermore, the input/output interface 2150 may output instructions or data received from (an)other element(s) of the electronic device 2101 to the user or another external device.

The display 2160 may include, for example, a liquid crystal display (LCD), a light-emitting diode (LED) display, an organic light-emitting diode (OLED) display, a microelectromechanical systems (MEMS) display, or an electronic paper display. The display 2160 may present various content (e.g., a text, an image, a video, an icon, a symbol, or the like) to the user. The display 2160 may include a touch screen, and may receive a touch, gesture, proximity or hovering input from an electronic pen or a part of a body of the user.

The communication interface 2170 may set communications between the electronic device 2101 and an external device (e.g., a first external electronic device 2102, a second external electronic device 2104, or a server 2106). For example, the communication interface 2170 may be connected to a network 2162 via wireless communications or wired communications so as to communicate with the external device (e.g., the second external electronic device 2104 or the server 2106).

The wireless communications may employ at least one of cellular communication protocols such as long-term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 2164. The short-range communications may include at least one of Wi-Fi, BT, near field communication (NFC), magnetic stripe transmission (MST), or GNSS.

The MST may generate pulses according to transmission data and the pulses may generate electromagnetic signals. The electronic device 2101 may transmit the electromagnetic signals to a reader device such as a POS (point of sales) device. The POS device may detect the magnetic signals by using a MST reader and restore data by converting the detected electromagnetic signals into electrical signals.

The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), high definition multimedia interface (HDMI), recommended standard 832 (RS-232), plain old telephone service (POTS), or the like. The network 2162 may include at least one of telecommunications networks, for example, a computer network (e.g., local area network (LAN) or wide area network (WAN)), the Internet, or a telephone network.

The types of the first external electronic device 2102 and the second external electronic device 2104 may be the same as or different from the type of the electronic device 2101. According to an embodiment of the present disclosure, the server 2106 may include a group of one or more servers. A portion or all of operations performed in the electronic device 2101 may be performed in one or more other electronic devices (e.g., the first external electronic device 2102, the second external electronic device 2104, or the server 2106). When the electronic device 2101 should perform a certain function or service automatically or in response to a request, the electronic device 2101 may request at least a portion of functions related to the function or service from another device (e.g., the first external electronic device 2102, the second external electronic device 2104, or the server 2106) instead of or in addition to performing the function or service for itself. The other electronic device (e.g., the first external electronic device 2102, the second external electronic device 2104, or the server 2106) may perform the requested function or additional function, and may transfer a result of the performance to the electronic device 2101. The electronic device 2101 may use a received result itself or additionally process the received result to provide the requested function or service. To this end, for example, a cloud computing technology, a distributed computing technology, or a client-server computing technology may be used.

According to various embodiments, as a server for streaming an image on an external electronic device, the server device includes a communication module configured to establish a plurality of channels with the external electronic device, a map generating unit configured to map a two-dimensional (2D) image to each face constituting a 3D space, an encoding unit configured to layer image data corresponding to at least one surface constituting the 3D space to vary in image quality information, and a database configured to store the layered image data.

According to various embodiments, the encoding unit is configured to generate the image data of a quadrangular frame by adding dummy data.

According to various embodiments, the encoding unit is configured to generate the image data of a quadrangular frame by recombining image data corresponding to a plurality of adjacent faces of the 3D space.

According to various embodiments, the plurality of channels are linked to each face constituting the 3D space.

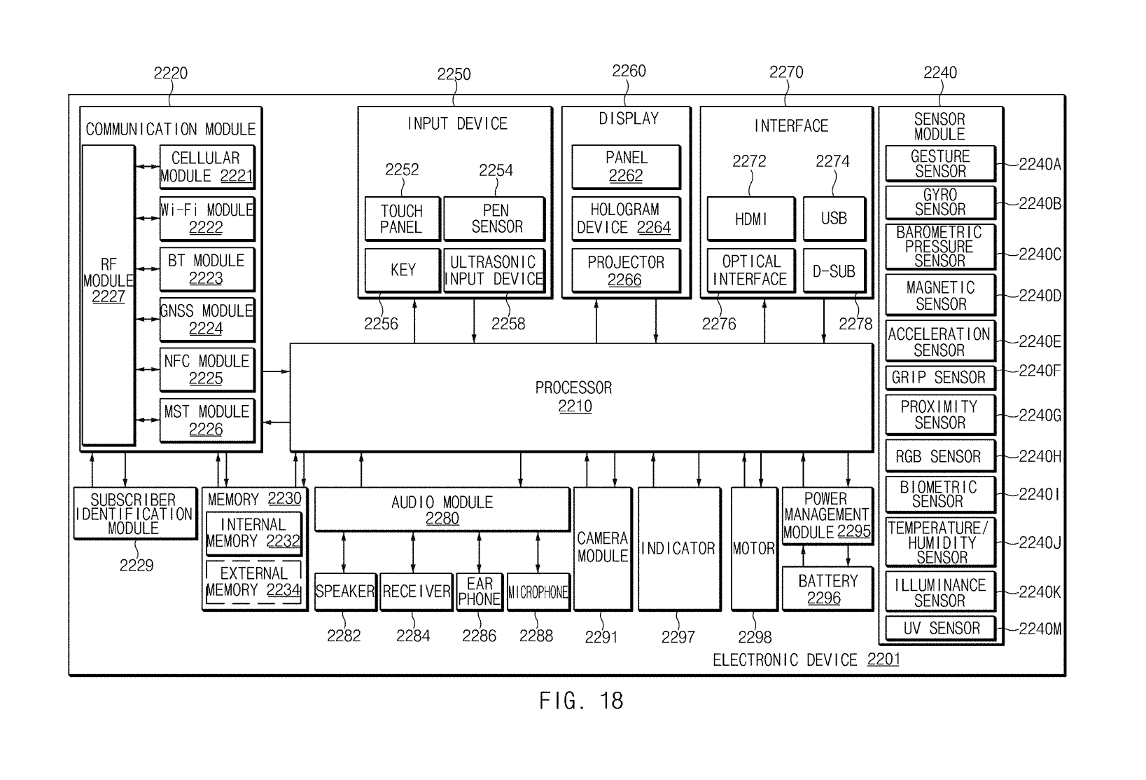

FIG. 18 is a block diagram illustrating an electronic device according to various embodiments of the present disclosure.

Referring to FIG. 18, an electronic device 2201 may include, for example, a part or the entirety of the electronic device 2101 illustrated in FIG. 17. The electronic device 2201 may include at least one processor (e.g., AP) 2210, a communication module 2220, a subscriber identification module (SIM) 2229, a memory 2230, a sensor module 2240, an input device 2250, a display 2260, an interface 2270, an audio module 2280, a camera module 2291, a power management module 2295, a battery 2296, an indicator 2297, and a motor 2298.

The processor 2210 may run an operating system or an application program so as to control a plurality of hardware or software elements connected to the processor 2210, and may process various data and perform operations. The processor 2210 may be implemented with, for example, a system on chip (SoC). According to an embodiment of the present disclosure, the processor 2210 may further include a graphic processing unit (GPU) and/or an image signal processor (ISP). The processor 2210 may include at least a portion (e.g., a cellular module 2221) of the elements illustrated in FIG. 18. The processor 2210 may load, on a volatile memory, an instruction or data received from at least one of other elements (e.g., a nonvolatile memory) to process the instruction or data, and may store various data in a nonvolatile memory.

The communication module 2220 may have a configuration that is the same as or similar to that of the communication interface 2170 of FIG. 17. The communication module 2220 may include, for example, a cellular module 2221, a Wi-Fi module 2222, a BT module 2223, a GNSS module 2224 (e.g., a GPS module, a GLONASS module, a BeiDou module, or a Galileo module), a NFC module 2225, a MST module 2226 and a radio frequency (RF) module 2227.

The cellular module 2221 may provide, for example, a voice call service, a video call service, a text message service, or an Internet service through a communication network. The cellular module 2221 may identify and authenticate the electronic device 2201 in the communication network using the SIM 2229 (e.g., a SIM card). The cellular module 2221 may perform at least a part of functions that may be provided by the processor 2210. The cellular module 2221 may include a CP.

Each of the Wi-Fi module 2222, the BT module 2223, the GNSS module 2224 and the NFC module 2225 may include, for example, a processor for processing data transmitted/received through the modules. According to some various embodiments of the present disclosure, at least a part (e.g., two or more) of the cellular module 2221, the Wi-Fi module 2222, the BT module 2223, the GNSS module 2224, and the NFC module 2225 may be included in a single integrated chip (IC) or IC package.

The RF module 2227 may transmit/receive, for example, communication signals (e.g., RF signals). The RF module 2227 may include, for example, a transceiver, a power amp module (PAM), a frequency filter, a low noise amplifier (LNA), an antenna, or the like. According to another embodiment of the present disclosure, at least one of the cellular module 2221, the Wi-Fi module 2222, the BT module 2223, the GNSS module 2224, or the NFC module 2225 may transmit/receive RF signals through a separate RF module.

The SIM 2229 may include, for example, an embedded SIM and/or a card containing the subscriber identity module, and may include unique identification information (e.g., an integrated circuit card identifier (ICCID)) or subscriber information (e.g., international mobile subscriber identity (IMSI)).

The memory 2230 (e.g., the memory 2130) may include, for example, an internal memory 2232 or an external memory 2234. The internal memory 2232 may include at least one of a volatile memory (e.g., a dynamic RAM (DRAM), a static RAM (SRAM), a synchronous dynamic RAM (SDRAM), or the like), a nonvolatile memory (e.g., a read only memory (ROM), a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, or the like)), a hard drive, or a solid state drive (SSD).

The external memory 2234 may include a flash drive such as a compact flash (CF), a secure digital (SD), a micro-SD, a mini-SD, an extreme digital (xD), a MultiMediaCard (MMC), a memory stick, or the like. The external memory 2234 may be operatively and/or physically connected to the electronic device 2201 through various interfaces.

The sensor module 2240 may, for example, measure physical quantity or detect an operation state of the electronic device 2201 so as to convert measured or detected information into an electrical signal. The sensor module 2240 may include, for example, at least one of a gesture sensor 2240A, a gyro sensor 2240B, a barometric pressure sensor 2240C, a magnetic sensor 2240D, an acceleration sensor 2240E, a grip sensor 2240F, a proximity sensor 2240G, a color sensor 2240H (e.g., a red/green/blue (RGB) sensor), a biometric sensor 2240I, a temperature/humidity sensor 2240J, an illumination sensor 2240K, or an ultraviolet (UV) sensor 2240M. Additionally or alternatively, the sensor module 2240 may include, for example, an olfactory sensor (E-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 2240 may further include a control circuit for controlling at least one sensor included therein. In some various embodiments of the present disclosure, the electronic device 2201 may further include a processor configured to control the sensor module 2240 as a part of the processor 2210 or separately, so that the sensor module 2240 is controlled while the processor 2210 is in a sleep state.

The input device 2250 may include, for example, a touch panel 2252, a (digital) pen sensor 2254, a key 2256, or an ultrasonic input device 2258. The touch panel 2252 may employ at least one of capacitive, resistive, infrared, and ultraviolet sensing methods. The touch panel 2252 may further include a control circuit. The touch panel 2252 may further include a tactile layer so as to provide a haptic feedback to a user.

The (digital) pen sensor 2254 may include, for example, a sheet for recognition which is a part of a touch panel or is separate. The key 2256 may include, for example, a physical button, an optical button, or a keypad. The ultrasonic input device 2258 may sense ultrasonic waves generated by an input tool through a microphone 2288 so as to identify data corresponding to the ultrasonic waves sensed.

The display 2260 (e.g., the display 2160) may include a panel 2262, a hologram device 2264, or a projector 2266. The panel 2262 may have a configuration that is the same as or similar to that of the display 2160 of FIG. 17. The panel 2262 may be, for example, flexible, transparent, or wearable. The panel 2262 and the touch panel 2252 may be integrated into a single module. The hologram device 2264 may display a stereoscopic image in a space using a light interference phenomenon. The projector 2266 may project light onto a screen so as to display an image. The screen may be disposed in the inside or the outside of the electronic device 2201. According to an embodiment of the present disclosure, the display 2260 may further include a control circuit for controlling the panel 2262, the hologram device 2264, or the projector 2266.

The interface 2270 may include, for example, an HDMI 2272, a USB 2274, an optical interface 2276, or a D-subminiature (D-sub) 2278. The interface 2270, for example, may be included in the communication interface 2170 illustrated in FIG. 17. Additionally or alternatively, the interface 2270 may include, for example, a mobile high-definition link (MHL) interface, an SD card/MMC interface, or an infrared data association (IrDA) interface.

The audio module 2280 may convert, for example, a sound into an electrical signal or vice versa. At least a portion of elements of the audio module 2280 may be included in the input/output interface 2150 illustrated in FIG. 17. The audio module 2280 may process sound information input or output through a speaker 2282, a receiver 2284, an earphone 2286, or the microphone 2288.

The camera module 2291 is, for example, a device for shooting a still image or a video. According to an embodiment of the present disclosure, the camera module 2291 may include at least one image sensor (e.g., a front sensor or a rear sensor), a lens, an ISP, or a flash (e.g., an LED or a xenon lamp).

The power management module 2295 may manage power of the electronic device 2201. According to an embodiment of the present disclosure, the power management module 2295 may include a power management integrated circuit (PMIC), a charger integrated circuit (IC), or a battery or gauge. The PMIC may employ a wired and/or wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 2296 and a voltage, current or temperature thereof while the battery is charged. The battery 2296 may include, for example, a rechargeable battery and/or a solar battery.

The indicator 2297 may display a specific state of the electronic device 2201 or a part thereof (e.g., the processor 2210), such as a booting state, a message state, a charging state, or the like. The motor 2298 may convert an electrical signal into a mechanical vibration, and may generate a vibration or haptic effect. Although not illustrated, a processing device (e.g., a GPU) for supporting a mobile TV may be included in the electronic device 2201. The processing device for supporting a mobile TV may process media data according to the standards of digital multimedia broadcasting (DMB), digital video broadcasting (DVB), MediaFLO™, or the like.

Each of the elements described herein may be configured with one or more components, and the names of the elements may be changed according to the type of an electronic device. In various embodiments of the present disclosure, an electronic device may include at least one of the elements described herein, and some elements may be omitted or other additional elements may be added. Furthermore, some of the elements of the electronic device may be combined with each other so as to form one entity, so that the functions of the elements may be performed in the same manner as before the combination.

According to various embodiments, an electronic device for outputting an image, the electronic device includes a display configured to output the image, a communication module configured to establish a plurality of channels with an external electronic device, a memory, and a processor configured to be electrically connected with the display, the communication module, and the memory, wherein the processor is configured to classify a virtual 3D projection space around the electronic device into a plurality of regions and link each of the plurality of regions with one of the plurality of channels, receive image data over the channel linked to each of the plurality of regions via the communication module from the external electronic device; and output a streaming image on the display based on the received image data.

According to various embodiments, the electronic device further includes a sensor module configured to recognize motion or movement of a user or the electronic device, wherein the sensor module is configured to collect sensing information about a direction corresponding to a line of sight of the user, and wherein the processor is configured to determine a region corresponding to a FOV determined by the direction among the plurality of regions, based on the sensing information.

According to various embodiments, the processor is configured to determine image quality of image data for at least one of the plurality of regions based on an angle between a first vector facing a central point of the FOV from a reference point of the 3D projection space and a second vector facing a central point of each of the plurality of regions from the reference point.

According to various embodiments, the processor is configured to map the plurality of regions to a spherical surface, and determine image quality of image data for at least one of the plurality of regions based on a spherical distance between a central point of each of the plurality of regions and a central point of the FOV.

According to various embodiments, the direction corresponding to the line of sight is a direction perpendicular to a surface of the display.

According to various embodiments, the communication module is configured to receive first image data of first image quality over a first channel linked to the region corresponding to the FOV, and receive second image data of second image quality over a second channel linked to a peripheral region adjacent to the FOV, and the processor is configured to output an image of the FOV based on the first image data, and output an image of the peripheral region based on the second image data.

According to various embodiments, the processor is configured to determine output timing between first video data included in the first image data and second video data included in the second image data with respect to audio data included in the image data.

According to various embodiments, the processor is configured to skip an image output by the second image data for an image interval, if buffering occurs in the second image data.

According to various embodiments, the processor is configured to duplicate and receive the second image data for an image interval and replace the received second image data with at least part of the second image data previously received, if the FOV is changed.

According to various embodiments, the processor is configured to receive third image data of third image quality over a third channel linked to a separation region separated from the region corresponding to the FOV via the communication module, and output an image of the separation region based on the third image data.

According to various embodiments, the processor is configured to limit reception of image data over a third channel linked to a separation region separated from the region corresponding to the FOV.

According to various embodiments, the processor is configured to determine an image quality range of image data received over a channel linked to each of the plurality of regions, based on wireless communication performance.

According to various embodiments, the processor is configured to group the plurality of regions into a plurality of groups, and output a streaming image for each of the plurality of groups based on image data of different image quality.

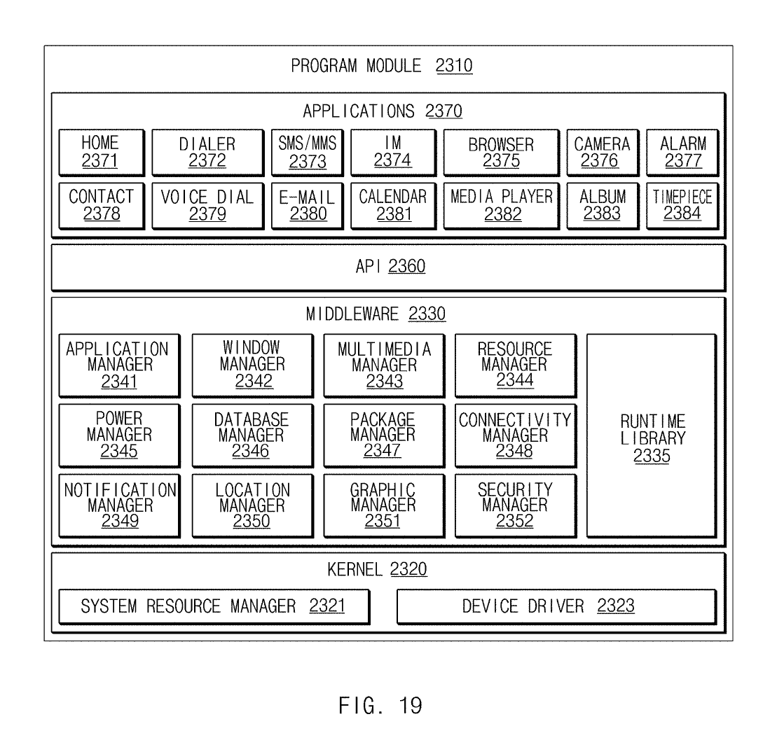

FIG. 19 is a block diagram illustrating a configuration of a program module 2310 according to an embodiment of the present disclosure.

Referring to FIG. 19, the program module 2310 (e.g., a program 2140 of FIG. 17) may include an OS for controlling resources associated with an electronic device (e.g., an electronic device 2101 of FIG. 17) and/or various applications (e.g., an application program 2147 of FIG. 17) which are executed on the OS. The OS may be, for example, Android, iOS, Windows, Symbian, Tizen, or Bada, and the like.

The program module 2310 may include a kernel 2320, a middleware 2330, an API 2360, and/or an application 2370. At least part of the program module 2310 may be preloaded on the electronic device, or may be downloaded from an external electronic device (e.g., a first external electronic device 2102, a second external electronic device 2104, or a server 2106, and the like of FIG. 17).

The kernel 2320 (e.g., a kernel 2141 of FIG. 17) may include, for example, a system resource manager 2321 and/or a device driver 2323. The system resource manager 2321 may control, assign, or collect, and the like system resources. According to an embodiment of the present disclosure, the system resource manager 2321 may include a process management unit, a memory management unit, or a file system management unit, and the like. The device driver 2323 may include, for example, a display driver, a camera driver, a BT driver, a shared memory driver, a USB driver, a keypad driver, a Wi-Fi driver, an audio driver, or an IPC driver.

The middleware 2330 (e.g., a middleware 2143 of FIG. 17) may provide, for example, functions the application 2370 needs in common, and may provide various functions to the application 2370 through the API 2360 such that the application 2370 efficiently uses limited system resources in the electronic device. According to an embodiment of the present disclosure, the middleware 2330 (e.g., the middleware 2143) may include at least one of a runtime library 2335, an application manager 2341, a window manager 2342, a multimedia manager 2343, a resource manager 2344, a power manager 2345, a database manager 2346, a package manager 2347, a connectivity manager 2348, a notification manager 2349, a location manager 2350, a graphic manager 2351, a security manager 2352, or a payment manager 2354.

The runtime library 2335 may include, for example, a library module used by a compiler to add a new function through a programming language while the application 2370 is executed. The runtime library 2335 may perform a function about input and output management, memory management, or an arithmetic function.

The application manager 2341 may manage, for example, a life cycle of at least one of the application 2370. The window manager 2342 may manage GUI resources used on a screen of the electronic device. The multimedia manager 2343 may determine a format utilized for reproducing various media files and may encode or decode a media file using a codec corresponding to the corresponding format. The resource manager 2344 may manage source codes of at least one of the application 2370, and may manage resources of a memory or a storage space, and the like.

The power manager 2345 may act together with, for example, a BIOS and the like, may manage a battery or a power source, and may provide power information utilized for an operation of the electronic device. The database manager 2346 may generate, search, or change a database to be used in at least one of the application 2370. The package manager 2347 may manage installation or update of an application distributed by a type of a package file.

The connectivity manager 2348 may manage, for example, wireless connection such as Wi-Fi connection or BT connection, and the like. The notification manager 2349 may display or notify events, such as an arrival message, an appointment, and proximity notification, by a method which is not disturbed to the user. The location manager 2350 may manage location information of the electronic device. The graphic manager 2351 may manage a graphic effect to be provided to the user or UI related to the graphic effect. The security manager 2352 may provide all security functions utilized for system security or user authentication, and the like. According to an embodiment of the present disclosure, when the electronic device (e.g., an electronic device 2101 of FIG. 17) has a phone function, the middleware 2330 may further include a telephony manager (not shown) for managing a voice or video communication function of the electronic device.

The middleware 2330 may include a middleware module which configures combinations of various functions of the above-described components. The middleware 2330 may provide a module which specializes according to kinds of operating systems (OSs) to provide a differentiated function. Also, the middleware 2330 may dynamically delete some of old components or may add new components.

The API 2360 (e.g., an API 2145 of FIG. 17) may be, for example, a set of API programming functions, and may be provided with different components according to OS s. For example, in case of Android or iOS, one API set may be provided according to platforms. In case of Tizen, two or more API sets may be provided according to platforms.

The application 2370 (e.g., an application program 2147 of FIG. 17) may include one or more of, for example, a home application 2371, a dialer application 2372, an SMS/MMS application 2373, an IM application 2374, a browser application 2375, a camera application 2376, an alarm application 2377, a contact application 2378, a voice dial application 2379, an e-mail application 2380, a calendar application 2381, a media player application 2382, an album application 2383, a timepiece (i.e., a clock) application 2384, a payment application (not shown), a health care application (e.g., an application for measuring quantity of exercise or blood sugar, and the like) (not shown), or an environment information application (e.g., an application for providing atmospheric pressure information, humidity information, or temperature information, and the like) (not shown), and the like.

According to an embodiment of the present disclosure, the application 2370 may include an application (hereinafter, for better understanding and ease of description, referred to as “information exchange application”) for exchanging information between the electronic device (e.g., the electronic device 2101 of FIG. 17) and an external electronic device (e.g., the first external electronic device 2102 or the second external electronic device 2104). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first external electronic device 2102 or the second external electronic device 2104). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the first external electronic device 2102 or the second external electronic device 2104) which communicates with the electronic device, an application which operates in the external electronic device, or a service (e.g., a call service or a message service) provided from the external electronic device.

According to an embodiment of the present disclosure, the application 2370 may include an application (e.g., the health card application of a mobile medical device) which is preset according to attributes of the external electronic device (e.g., the first external electronic device 2102 or the second external electronic device 2104). According to an embodiment of the present disclosure, the application 2370 may include an application received from the external electronic device (e.g., the server 2106, the first external electronic device 2102, or the second external electronic device 2104). According to an embodiment of the present disclosure, the application 2370 may include a preloaded application or a third party application which may be downloaded from a server. Names of the components of the program module 2310 according to various embodiments of the present disclosure may differ according to kinds of OSs.

According to various embodiments of the present disclosure, at least part of the program module 2310 may be implemented with software, firmware, hardware, or at least two or more combinations thereof. At least part of the program module 2310 may be implemented (e.g., executed) by, for example, a processor (e.g., a processor 2210). At least part of the program module 2310 may include, for example, a module, a program, a routine, sets of instructions, or a process, and the like for performing one or more functions.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device for outputting an image, the electronic device comprising:
a display configured to output the image;
a transceiver configured to establish a plurality of channels with an external electronic device; and
a processor configured to:
classify a virtual three dimensional (3D) projection space around the electronic device into a plurality of regions,
link each of the plurality of regions with one of the plurality of channels,
receive image data over each channel linked to each of the plurality of regions via the transceiver from the external electronic device, and
output a streaming image on the display based on the image data.

2. The electronic device of claim 1, further comprising:
a sensor module configured to collect sensing information related to a line of sight of the user,
wherein the processor is further configured to determine a first region corresponding to a field of view (FOV) among the plurality of regions based on the sensing information.

3. The electronic device of claim 2, wherein the processor is further configured to determine an image quality of image data for at least one of the plurality of regions based on an angle between a first vector facing a central point of the FOV from a reference point of the 3D projection space and a second vector facing a central point of each of the plurality of regions from the reference point.

4. The electronic device of claim 2, wherein the processor is further configured to:
map the plurality of regions to a spherical surface, and
determine an image quality of an image data for at least one of the plurality of regions based on a spherical distance between a central point of each of the plurality of regions and a central point of the FOV.

5. The electronic device of claim 2, wherein the line of sight is normal to a surface of the display.

6. The electronic device of claim 2,
wherein the transceiver is further configured to:
receive first image data of a first image quality over a first channel linked to the first region, and
receive second image data of a second image quality over a second channel linked to a second region that is adjacent to the FOV, and
wherein the processor is further configured to:
output an image in the first region based on the first image data, and
output an image in the second region based on the second image data.

7. The electronic device of claim 6, wherein the processor is further configured to determine an output timing between first video data included in the first image data and second video data included in the second image data with respect to audio data included in the first image data and the second image data.

8. The electronic device of claim 6, wherein the processor is configured to, if buffering occurs in the second image data, skip an image output by the second image data during an image interval.

9. The electronic device of claim 6, wherein the processor is further configured to, if the FOV changes, duplicate and receive the second image data for an image interval and replace the received second image data with at least part of the second image data previously received.

10. The electronic device of claim 2, wherein the processor is further configured to:
receive third image data of a third image quality over a third channel linked to a third region that is separated from the first region via the transceiver, and
output an image in the third region based on the third image data.

11. The electronic device of claim 10, wherein the processor is further configured to limit reception of the third image data.

12. The electronic device of claim 1, wherein the processor is further configured to determine an image quality range of image data received over each channel linked to each of the plurality of regions based on wireless communication performance.

13. The electronic device of claim 1, wherein the processor is further configured to:
group the plurality of regions into a plurality of groups, and
output a streaming image for each of the plurality of groups based on image data of different image quality.

14. A server for streaming an image on an external electronic device, the server comprising:
a transceiver configured to establish a plurality of channels with the external electronic device;
a processor configured to map a two-dimensional (2D) image to each face constituting a three dimensional (3D) space;
an encoder configured to layer image data corresponding to at least one surface constituting the 3D space to vary in image quality; and
a database configured to store the layered image data.

15. The server of claim 14, wherein the encoder is further configured to generate the image data having a quadrangular frame by adding dummy data.

16. The server of claim 14, wherein the encoder is further configured to generate the image data having a quadrangular frame by recombining image data corresponding to a plurality of adjacent faces of the 3D space.

17. The server of claim 14, wherein the plurality of channels are linked to each surface constituting the 3D space.

18. A method for streaming images in an electronic device, the method comprising:
classifying a virtual three dimensional (3D) projection space around the electronic device into a plurality of regions;
linking each of the plurality of regions with one of the plurality of channels associated with an external device;
receiving image data over each channel linked to each of the plurality of regions from the external device; and
outputting a streaming image on a display of the electronic device based on the image data.

19. The method of claim 18, wherein the receiving of the image data comprises:
collecting sensing information related to a line of sight of a user using a sensor module of the electronic device; and
determining a first region corresponding to a field of view (FOV) among the plurality of regions based on the sensing information.

20. The method of claim 19, wherein the receiving of the image data further comprises:
receiving first image data of a first image quality over a first channel linked to the first region; and
receiving second image data of a second image quality over a second channel linked to a second region adjacent to the first region.

21. A method for receiving streaming images in an electronic device, the method comprising:
when a line of sight associated with the electronic device corresponds to a first region, receiving a first image for a first region with a first quality and a second image for a second region with a second quality;
when the line of sight associated with the electronic device corresponds to the second region, receiving the first image for the first region with the second quality and the second image for the second region with a first quality; and
displaying the first image and the second image,
wherein the first quality and the second quality are different.
